(19) United States
(12) Patent Application Publication
(10) Pub. No.: US 2023/0139391 A1
(43) Pub. Date: May 4, 2023

(54) Systems And Methods For Privacy Conscious Market Collaboration

(71) Applicant: Google LLC, Mountain View, CA (US)

(72) Inventor: Sriram Krishna Parameswar, Bellevue, WA (US)

(21) Appl. No.: 17/515,048

(22) Filed: Oct. 29, 2021

(51) Int. Cl. H04L 29/06; G06Q 30/02

(52) U.S. Cl. CPC H04L 63/0428; G06Q 30/0255; G06Q 30/0269

(57) ABSTRACT

The present disclosure is directed to facilitating privacy conscious market collaboration. A first-party computing system can access a first-party user information attribute from a first-party identified user profile associated with a first-party identified user and generate a first-party hashed user information attribute including indecipherable text by applying a predetermined hash function. The system can transmit to a third-party computing system a communication including the first-party hashed user information attribute and a payload including customer insight data. The third-party computing system can determine that a third-party hashed user information attribute associated with a third-party identified user profile includes indecipherable text that matches the indecipherable text of the first-party hashed user information attribute. The third-party computing system can provide to a third-party identified user associated with the third-party identified user profile an advertisement that is based on the customer insight data in the payload of the communication.

### FIELD

The present disclosure relates generally to privacy-enabled communication techniques. More particularly, the present disclosure relates to privacy conscious communication techniques that leverage information independently obtained by multiple, different parties.

### BACKGROUND

Various forms of digital signal monitoring (e.g., indicative of a user's online activity) can be used to obtain and transfer data associated with a user between a number of different parties. A common digital signal monitoring technique involves using “cookies” (e.g., text files downloaded through a web browser). Cookies can be used to record digital signals such that the information can be accessed by third-parties (e.g., for creating personal websites, personalized ads, etc.). Cookies can be created by a webserver hosting a website (e.g., first-party cookies) or webservers different from a hosting webserver (e.g., third-party cookies). For instance, third-party cookies can include cookies associated with advertisements provided within a website. Therefore, visiting a website can result in multiple cookies being downloaded to a user's device. This enables parties unaffiliated with a user to nevertheless capture information associated with the user such as a user's search history, purchase history, and other personal information. There is a need for “cookie-less” data gathering and communication techniques that enable affiliated parties to collect and use information associated with a user, while preventing the release of such information to parties unaffiliated with the user.

### SUMMARY

Aspects and advantages of embodiments of the present disclosure will be set forth in part in the following description, or can be learned from the description, or can be learned through practice of the embodiments.

An example aspect can include a computer-implemented method. The method can include receiving, by a third-party computing system comprising one or more computing devices, a first-party communication including a first-party hashed user information attribute and a payload. The first-party hashed user information attribute can include indecipherable text generated by a first-party computing system applying a predetermined hash function to a first-party user information attribute from a first-party identified user profile maintained by the first-party computing system. The payload can include customer insight data for a first-party identified user associated with the first-party identified user profile. The method can include generating, by the third-party computing system, a plurality of third-party hashed user information attributes each including indecipherable text generated by applying the predetermined hash function to a respective third-party user information attribute from a plurality of third-party identified user profiles maintained by the third-party computing system. The method can include determining, by the third-party computing system, that the indecipherable text of a particular third-party hashed user information attribute matches the indecipherable text of the first-party hashed user information attribute in the first-party communication. The method can include selecting, by the third-party computing system, a particular third-party identified user profile that includes the respective third-party user information attribute from which the particular third-party hashed user information attribute was generated. And, the method can include providing, by the third-party computing system to a particular third-party identified user associated with the particular third-party identified user profile, an advertisement that is based on the customer insight data in the payload of the first-party communication.

Another example aspect can include a third-party computing system. The third-party computing system can include one or more processors; and a memory storing instructions that when executed by the one or more processors cause the third-party computing system to perform operations. The operations can include receiving a first-party communication including a first-party hashed user information attribute and a payload, the first-party hashed user information attribute including indecipherable text generated by a first-party computing system applying a predetermined hash function to a first-party user information attribute from a first-party identified user profile maintained by the first-party computing system, the payload including customer insight data for a first-party identified user associated with the first-party identified user profile. The operations can include generating a plurality of third-party hashed user information attributes each including indecipherable text generated by applying the predetermined hash function to a respective third-party user information attribute from a plurality of third-party identified user profiles maintained by the third-party computing system. The operations can include determining that the indecipherable text of a particular third-party hashed user information attribute matches the indecipherable text of the first-party hashed user information attribute in the first-party communication. The operations can include selecting a particular third-party identified user profile that includes the respective third-party user information attribute from which the particular third-party hashed user information attribute was generated. And, the operations include providing, to a particular third-party identified user associated with the particular third-party identified user profile, an advertisement that is based on the customer insight data in the payload of the first-party communication.

Yet another example aspect can include one or more non-transitory computer-readable media comprising instructions that when executed by one or more computing devices cause the one or more computing devices to perform operations. The operations include receiving a first-party communication including a first-party hashed user information attribute and a payload, the first-party hashed user information attribute including indecipherable text generated by a first-party computing system applying a predetermined hash function to a first-party user information attribute from a first-party identified user profile maintained by the first-party computing system, the payload including customer insight data for a first-party identified user associated with the first-party identified user profile. The operations include generating a plurality of third-party hashed user information attributes each including indecipherable text generated by applying the predetermined hash function to a respective third-party user information attribute from a plurality of third-party identified user profiles maintained by the third-party computing system. The operations include determining that the indecipherable text of a particular third-party hashed user information attribute matches the indecipherable text of the first-party hashed user information attribute in the first-party communication. The operations include selecting a particular third-party identified user profile that includes the respective third-party user information attribute from which the particular third-party hashed user information attribute was generated. And, the operations include providing, to a particular third-party identified user associated with the particular third-party identified user profile, an advertisement that is based on the customer insight data in the payload of the first-party communication.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1A depicts a data gathering technique using digital cookies that can be replaced by example aspects of the present disclosure;

FIG. 1B depicts a communication technique for transferring data in a privacy conscious, cookie-less manner according to example aspects of the present disclosure;

FIG. 1C depicts an example application of a privacy conscious communication technique for providing an advertisement in an information-poor circumstance according to example aspects of the present disclosure;

FIG. 2A depicts a secure, multi-platform marketing system according to example aspects of the present disclosure;

FIG. 2B depicts an example marketing environment according to example aspects of the present disclosure;

FIG. 3 depicts an example customer journey according to example aspects of the present disclosure;

FIG. 4 depicts an example inventory-aware messaging scenario according to example aspects of the present disclosure;

FIG. 5 depicts an example multi-party ecosystem according to example aspects of the present disclosure;

FIG. 6 depicts an example market analytics cloud computing platform according to example aspects of the present disclosure;

FIG. 7 depicts an example market analytics cloud computing platform user interface according to example aspects of the present disclosure;

FIG. 8 depicts an example activity diagram for privacy conscious market collaboration according to example aspects of the present disclosure;

FIG. 9 depicts an example user group type according to example aspects of the present disclosure;

FIG. 10 depicts an example block diagram for generating a privacy conscious communication according to example aspects of the present disclosure;

FIG. 11 depicts an example block diagram for referencing third-party users based on a privacy conscious communication according to example aspects of the present disclosure;

FIG. 12 depicts an example block diagram for identifying prospective third-party users based on the privacy conscious communication according to example aspects of the present disclosure;

FIG. 13 depicts an example method for providing a privacy conscious communication according to example aspects of the present disclosure;

FIG. 14 depicts an example method for providing service operations for a first-party according to example aspects of the present disclosure; and

FIG. 15 depicts an example method for performing user acquisition operations for a first-party according to example aspects of the present disclosure; and

FIG. 16 depicts example components of an example computing system according to example aspects of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Example aspects of the present disclosure are directed to enabling improved, privacy conscious, market collaboration. The present disclosure describes a system that enables unaffiliated parties to exchange customer information in a privacy conscious manner. For example, the system can include an orchestration service that enables merchants to securely connect with third-party advertising platforms and users thereof. The orchestration service enables the secure transfer of customer information obtained firsthand by merchants to third-party advertisement platforms without revealing the identity of the merchant's customers. This information can be leveraged by various advertising platforms to provide personalized advertisements to users through multiple channels maintained by the advertising platforms such as, for example, search browser interfaces, multimedia interfaces, social media platforms, etc. The orchestration service can be utilized with an intermediary market intelligence service to enable a merchant to selectively and securely distribute customer insights with instructions for messaging users of the various third-party advertising platforms. This can allow a merchant to orchestrate personalized and consistent marketing campaigns across a number of different platforms/channels without endangering the privacy of its customers. The various third-party platforms can, in turn, receive highly relevant customer information typically only available to merchants, marketers, or other entities engaged in the exchange of goods.

The orchestration service can establish one or more secure communication standards (e.g., messaging format(s), cryptographic techniques, etc.) for providing information from a merchant to an advertiser. The communication standards can be provided to both a merchant and an advertiser for use in securely communicating and interpreting customer information. The communication standards can include a particular hashing algorithm. Hashing algorithms are used in multiple contexts to guarantee data integrity and/or data validation. However, the orchestration service can utilize particular hashing algorithms in a novel manner to ensure customer/user confidentiality. As an example, the orchestration service can instruct the use of a particular hashing algorithm for hashing user information attributes that uniquely identify a merchant's customer or an advertiser's user. The user information attributes can include unique identifying units of information for customers or users such as an email address, a phone number, a first name, last name, zip code, etc. The particular hashing algorithm and, in some cases, the types of information to hash (e.g., an email address, etc.) can be provided to both the merchant and the advertiser.

The merchant can receive information descriptive of a number of different interactions between the merchant and customers (or potential customers) thereof. The information can include transactional information (e.g., purchases, etc.), customer preferences (e.g., product inquiries, etc.), product inventory, etc. In some cases, the merchant can utilize tools provided by the intermediary market intelligence service to determine insights for its customers (and/or potential customers) such as, for example, an interest level in a product offered by the merchant, etc. The merchant can generate a payload of information indicative of a customer insight or data descriptive of a recent purchase, product inquiry, etc. and provide the payload to an advertiser using the secure communication standards prescribed by the orchestration service.

To do so, the merchant can obtain user information attributes for a particular customer (e.g., types of user information attributes identified by the orchestration service) and individually hash each user information attribute using the particular hashing algorithm as instructed by the orchestration service. The hashing algorithm can output an individual first-party hashed user information attribute for each user information attribute obtained by the merchant for the particular customer. Each hashed user information attribute is a fixed sized bit string (e.g., a message digest) unique to a corresponding user information attribute (e.g., a message). Each hashed user information attribute (e.g., fixed sized bit string) can be indecipherable (e.g., cannot be reverse engineered) and deterministic with respect to the corresponding user information attribute. By way of example, each hashed user information attribute can include indecipherable text deterministic of a respective user information attribute input to a hash function.

The merchant can provide a communication including the payload and each first-party hashed user information attribute to the advertiser. The advertiser can apply the same hashing algorithm (as instructed by the orchestration service), individually, to each user information attribute available to the advertiser (e.g., through interaction with their own third-party users) and cross reference the resulting individual third-party hashed user information attributes with each of the first-party hashed user information attributes of the communication. The advertiser can determine a third-party identified user profile corresponding to the communication in the event that at least one of the individual third-party hashed user information attributes match an individual first-party hashed user information attribute included in the communication. For instance, an individual third-party hashed user information attribute can match an individual first-party hashed user information attribute in the event that the indecipherable text of the individual third-party hashed user information attribute exactly matches the indecipherable text of the individual first-party hashed user information attribute. The advertiser can provide an advertisement to a third-party user corresponding to the third-party identified user profile based on the payload of the communication.

In this way, an orchestration service can govern the distribution of merchant information to a number of different advertisement platforms such that the information is only usable by platforms independently associated with customers referenced by the merchant information. For example, each hashed user information attribute can include an indecipherable string of characters. The indecipherable string of characters can be unique to a particular user information attribute used as the basis for the hashed user information attribute. The hashed user information attribute is deterministic of an input user information attribute and cannot be recreated by hashing similar or unrelated strings of information. Therefore, an advertiser (or any other recipient of a marketing communication) can only generate a third-party hashed user information attribute matching (e.g., with indecipherable text exactly matching) a first-party hashed user information attribute provided in a merchant's communication if the advertiser can independently hash the exact same user information attribute used as the basis for the first-party hashed user information attribute. Thus, insights provided from a merchant to a third-party platform can only be usable by third-party platforms that have independently received a user information attribute from a customer. Accordingly, the merchant can distribute customer insights or other customer information to a number of different platforms without disclosing insights or the identity of its customers to parties unaffiliated with its customers.

With reference now to the figures, example aspects of the present disclosure will be discussed in greater detail.

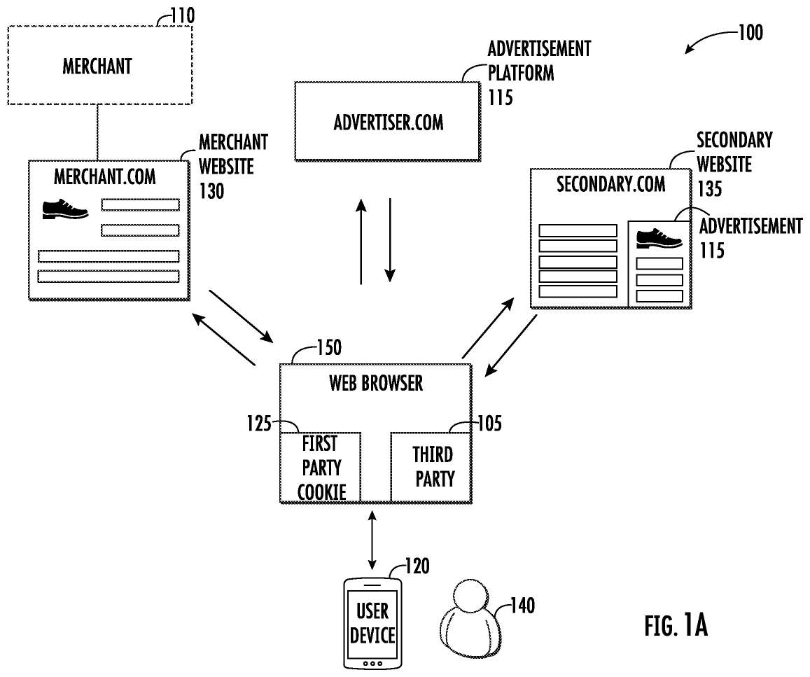

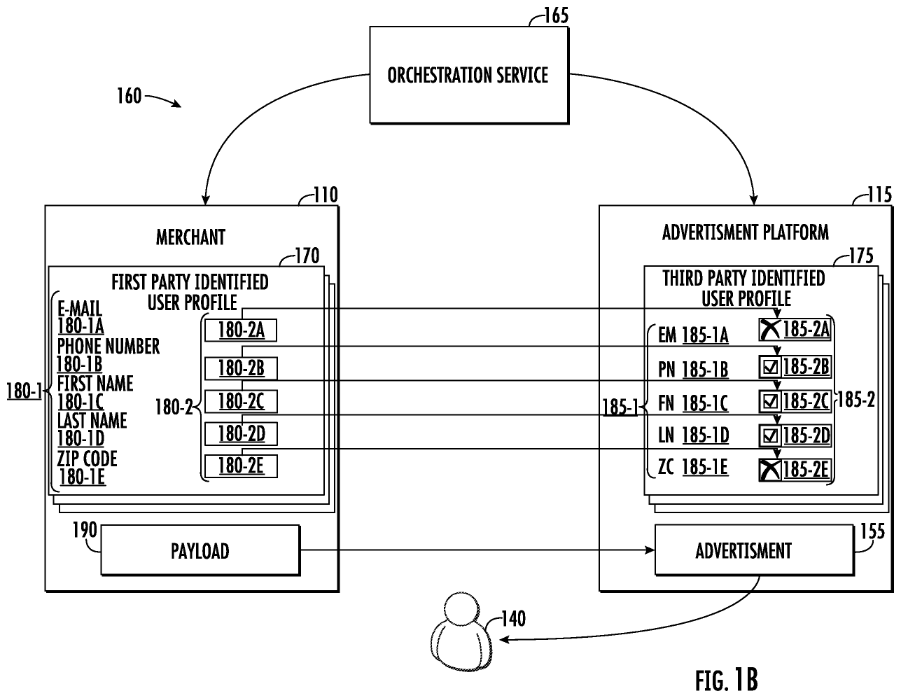

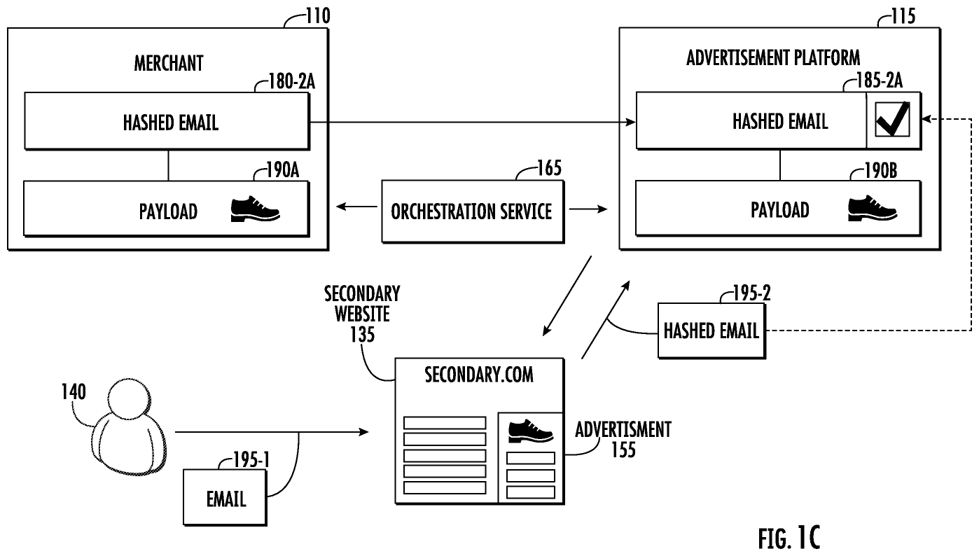

FIG. 1A depicts a data gathering technique 100 using digital cookies that can be replaced by example aspects of the present disclosure. The data gathering techniques 100 involve using a third-party cookie 105 to collect information related to an interaction between a customer 140 and a merchant 110. The term customer 140 is used to describe any person (or entity) that interacts with a merchant 110 to buy, browse for, and/or otherwise interact with products or services offered by the merchant 110. The customer 140 can include a person (or entity such as an organization) that buys products or services from the merchant 110 or potential customers that have shown an interest in the merchant 110 or products/services offered by the merchant 110. The term merchant 110 describes any entity involved in the supply of products or services to customers. The merchant 110 can include a product manufacturer, retailer, distributor, designer, publisher, etc. that creates and/or offers for sale products and/or services to customers such as, for example, customer 140. To do so, the merchant 110 can host and/or otherwise be affiliated with a merchant website 130 (e.g., “merchant.com”) that includes product/service information and/or offers a number of products, services, etc. for sale to the customer 140. By way of example, the merchant 110 can include a shoe retailer that hosts a merchant website 130 providing information and enabling the customer 140 to purchase shoes and other related merchandise from the merchant 110.

The data gathering techniques 100 illustrate a scenario in which an advertisement platform 115 leverages a third-party cookie 105 to indirectly obtain customer information for the customer 140 from the customer's digital interaction with the merchant website 130 to create an advertisement 155 personalized to the customer 140. An advertisement platform 115 can be any entity that collaborates with the merchant 110 to advertise the merchant's products or services to the customer 140. The advertisement platform 115 can do so in a variety of ways using different marketing channels including, for example, website interfaces, multimedia interfaces, social media platforms, etc. One example of a marketing channel can include an advertising website (e.g., “advertiser.com”) hosted and/or otherwise affiliated with the advertisement platform 115. As another example, a marketing channel can include one or more secondary website(s) 135 (e.g., “secondary.com”) through which the advertisement platform 115 can host advertisement(s) 155. The secondary website 135, for example, can include a social media website, a news outlet's website, a blog repository, or another content provider accessible to the customer 140.

The advertisement platform 115 typically does not sell products directly to the customer 140 and does not have access to firsthand customer information, such as transaction records, that could be helpful in providing personalized advertisements 155 to the customer 140. Due to concerns with revealing private information of its customers, the merchant 110 may be reluctant to provide such information to the advertisement platform 115 as customer information can include intimate details for the customer 140. Moreover, if communicated without taking proper security measures, communications with intimate details for the customer 140 could be intercepted by malicious parties allowing unintended recipients of a communication to gain personal insights for the customer 140. To compensate for the advertisement platform's lack of firsthand knowledge of the customer 140, the advertisement platform 115 can gain insights for the customer 140 by recording digital signals across a number of websites using third-party cookies 105.

By way of example, the customer 140 can interact with the merchant 110 by browsing the merchant's products or services through a merchant website 130. To do so, the customer 140 can execute a web browser 150 on the customer's personal device 120. The customer 140 can select the merchant website 130 from a list of search results provided by the web browser 150. In response, the web browser 150 can issue a request to a host webserver that hosts the merchant website 130 for information (e.g., HTML, CSS, JavaScript code, etc.) to render the merchant webpage 130 for the customer 140. If the web browser 150 has been previously used to access the merchant website 130, the request to the host webserver can include a first-party cookie 125 associated with the host webserver. The first-party cookie 125 includes a text file stored on the user device 120. The text file includes a name-value pair that identifies a first-party unique identifier for the customer 140 in association with the host webserver (e.g., a domain name). The first-party cookie 125 can be set by the host webserver the first time the customer 140 accesses the merchant website 130 using the web browser 150. Each time the web browser 150 issues a request to the domain associated with the first-party cookie 125, it will pass the first-party cookie 125 to the host webserver. In the event that the host webserver does not receive a first-party cookie 125 associated with the host webserver in a request for the merchant website 130, the host webserver can generate the first-party cookie 125 and can respond to the web browser 150 with information for rendering the merchant website 130 and a request to store the first-party cookie 125 in memory on the user device 120. The first-party cookie 125 can be stored on the user device 120 if granted permission by the user device 120 (and/or web browser 150).

When the web browser 150 issues another request to the host webserver, the web browser 150 can look up the first-party cookie 125 associated with the merchant website 130 and include the first-party cookie 125 in the request to the host webserver. In this way, the customer 140 can send the same first-party cookie 125 each time the customer 140 initiates another request to the host webserver by interacting with the merchant website 130. For instance, a new request can be issued when the customer 140 clicks on a product displayed by the merchant website 130. The new request can request information for rendering a webpage of the merchant website 130 associated with the selected product. Each time a new request is provided to the host webserver, the host webserver can store information provided by the request (e.g., that the customer 140 selected a particular product, etc.) in server memory and map the information to the first-party unique identifier of the first-party cookie 125. In addition, or alternatively, customer information for the customer 140 (e.g., that the customer selected the particular product, looked at a particular product for an extended time period, etc.) can be stored directly in the first-party cookie 125. In such a case, the web browser 150 can provide customer information for the customer 140 to the host webserver by providing the first-party cookie 125 to the host webserver with each request to the host webserver.

In this way, when the customer 140 returns to the merchant website 130, through the web browser 150, and the web browser 150 provides the first-party cookie 125 to the host webserver, the host webserver can access information associated with the customer's previous interactions with the merchant website 130 (e.g., by looking up information mapped to the first-party cookie 125, by obtaining the information directly from the first-party cookie 125 in the request, etc.) and provide information for rendering a personalized merchant website to the customer 140 based on the customer's previous interactions. This can include, for example, automatically entering customer credentials (e.g., a username, password, etc.) stored in association with the first-party cookie 125, providing personalized product recommendations based on product interests stored in association with the first-party cookie 125, etc.

The advertisement platform 115 can gain information for the customer 140 based on the customer's digital interactions with the merchant website 130 using a third-party cookie 105. The third-party cookie 105, for example, can include another text file stored on the user device 120 (e.g., if permitted by the user device 120 and/or web browser 150) that includes another name-value pair that identifies a third-party unique identifier for the customer 140 in association with the advertisement platform 115 (e.g., a domain name associated with the advertisement platform 115). The third-party cookie 105 can be used to record digital interactions between the customer 140 and website(s) that are not hosted by the advertisement platform 115. The third-party cookie 105, for example, can be retrieved by the advertisement platform 115 across a number of different websites that are not hosted by the advertisement platform 115 to record the customer's digital interactions with each of the number of different websites.

By way of example, the third-party cookie 105 can be set and/or retrieved by the advertisement platform 115 when the customer 140 uses the web browser 150 to access the merchant website 130. For instance, the web browser 150 can issue a request to the host webserver of the merchant website 130 as described herein. The host webserver can receive the request and respond with information to render the merchant website 130 and instructions to send a request to the advertisement platform 115. The instructions can redirect the web browser 150 to a third-party website (e.g., “advertiser.com”) affiliated with the advertisement platform 115 to allow the advertisement platform 115 to set and/or retrieve the third-party cookie 105. In other examples, the merchant website 130 may itself provide third-party cookie 105 to web browser 150.

For instance, the web browser 150 can issue a request to the advertisement platform 115 by retrieving any third-party cookie 105 associated with the advertisement platform 115 and providing the third-party cookie 105 to the advertisement platform 115. If the request to the advertisement platform 115 does not include a third-party cookie 105, the advertisement platform 115 can respond to the request with a request to set the third-party cookie 105. Once the third-party cookie 105 is set on the web browser 150, any future request from the web browser 150 to the advertisement platform 115 can include the third-party cookie 105 and information associated with the request such as, for example, the website (or specific webpage) in which the request was redirected from (e.g., the merchant website 130), an advertisement clicked on by the customer 140, etc. Each time a new request is provided to the advertisement platform 115, the advertisement platform 115 can store customer information provided by the request (e.g., that the customer 140 selected a particular product at the merchant website 130, etc.) in server memory and map the information to the third-party unique identifier of the third-party cookie 105. In addition, or alternatively, and as stated with respect to the first-party cookie 125, customer information associated with the customer 140 can be stored directly in the third-party cookie 105 and retrieved each time another request is issued to the advertisement platform 115.

The advertisement platform 115 can use information stored in association with the third-party cookie 105 to provide personalized advertisements 155 to the customer 140 when the customer 140 visits a secondary website 135 (e.g., “secondary.com”). For example, the secondary website 135 can include space for rendering third-party content such as the advertisement 155. In such a case, the information for rendering the secondary website 135 can include instructions for requesting third-party information from the advertisement platform 115. The web browser 150 can receive the instructions and issue a request to the advertisement platform 115 that includes the third-party cookie 105. The advertisement platform 115 can access information associated with the customer's previous interactions with affiliated websites, such as the merchant website 130, that initiate requests to the advertisement platform 115 (e.g., by looking up information mapped to the third-party cookie 105, by obtaining the information directly from the third-party cookie 105, etc.) and provide information for rendering a personalized advertisement 155 within the secondary website 135 based on the customer's previous interactions. This can include, for example, providing personalized product recommendations based on product interests determined by indirectly recording the customer's interactions with the merchant website 130 using the third-party cookie 105.

In the example of FIG. 1A, the merchant 110 is affiliated with the customer 140, because the customer 140 has made a conscious decision to visit the merchant web site 130 and interact with it. In contrast, no such affiliation exists between the advertisement platform 115 and the customer 140. While helpful for marketing purposes, third-party cookies 105 can be intrusive and present privacy risks to the customer 140 because they can be set by parties, such as advertisement platform 115, unaffiliated with the customer 140. Third-party cookies can also be unreliable and provide different insights for the customer 140 depending on where the third-party cookies 105 are used. In addition, the efficacy of any cookie can be eliminated at any time by deleting the cookie from a web browser, thereby resetting the customer information available to an advertiser. This results in cookie-based advertisements that can be inconsistent and, in some cases, irrelevant for the customer 140. The technology of the present disclosure can enable the merchant 110 and the advertisement platform 115 to determine and securely distribute insights corresponding to the customer 140 without the use of cookies (e.g., first-party cookie 125 or third-party cookie 105) or other digital signals that record the customer's internet activity.

FIG. 1B depicts a communication technique 160 for transferring data in a privacy conscious, cookie-less manner according to example aspects of the present disclosure. The communication technique 160 can replace the data gathering techniques 100 of FIG. 1A by enabling the merchant 110 to provide customer information obtained directly from the customer 140 to the advertisement platform 115 without exposing personal details of the customer 140 to the advertisement platform 115. The communication technique 160 involves drawing inferences for the customer 140 by matching indecipherable hashes (e.g., hashed user information attribute(s) 180-2, 185-2) of individual customer identifiers (e.g., user information attribute(s) 180-1, 185-1) independently obtained from the customer 140 by the merchant 110 and the advertisement platform 115.

User information attribute(s) 180-1, 185-1 can include units of information that uniquely identify, by themselves or in combination with other user information attributes 180-1, 185-1, the customer 140. Examples include email addresses 180-1A, 185-1A, phone numbers 180-1B, 185-1B, first names 180-1C, 185-1C, last names 180-1D, 185-1D, zip codes 180-1E, 185-1E, IP addresses, credit card numbers, billing addresses, usernames, or any other attributes at least partially unique to the customer 140. Certain user information attributes 180-1, 185-1 can uniquely identify the customer 140 by themselves, while others can be combined to identify the customer 140 within a reasonable certainty. For instance, an email address 180-1A, 185-1A or a phone number 180-1B, 185-1B used by the customer 140 can uniquely identify the customer 140, whereas a first name 180-1C, 185-1C can be combined with a last name 180-1D, 185-1D and zip code 180-1E, 185-1E to uniquely identify the customer 140. In some implementations, each user information attribute 180-1, 185-1 can be associated with a confidence level indicative of a confidence in the identity of the customer 140. In such a case, the customer 140 can be identified in the event that a number of user information attributes 180-1, 185-1 obtained for the customer 140 achieve a threshold confidence level.

The merchant 110 and the advertisement platform 115 can independently interact with the customer 140 to obtain user information attributes 180-1, 185-1, respectively. For example, the merchant 110 can collect first-party user information attributes 180-1 from the customer 140 through the course of providing a product, service, or information thereof to the customer 140. As an example, the customer 140 can provide a first-party email 180-1A or a first-party phone number 180-1B to the merchant 110 to sign up for a subscription service, to receive a discount, etc. As another example, the customer 140 can provide user information attributes 180-1 to the merchant while buying a product from the merchant 110. For instance, the customer 140 can pay for the product using a credit card and, to verify the purchase, provide a first-party first name 180-1C, a first-party last name 180-1D, and/or a first-party zip code 180-1E. In some implementations, the customer 140 can create a user account with the merchant 110 and provide the first-party user information attributes 180-1 during the creation of the user account. The merchant 110 can obtain the first-party user information attributes 180-1 in any of a plurality of scenarios, a person of ordinary skill in the art would understand that the examples provided herein are just a few of the possible scenarios.

Separately and independently from the merchant 110, and based on its own, separate affiliation with customer 140, the advertisement platform 115 can interact with the customer 140 and, in the course of providing its own separate services, will obtain third-party user information attributes 185-1. For instance, the advertisement platform 115 can be associated with a service that encourages user engagement. By way of example, the advertisement platform 115 can include a social media platform that allows the customer 140 to create an account to engage with users of the social media platform. As another example, the advertisement platform 115 can include a search browser that enables the customer 140 to create an account to seamlessly search the internet. During the creation of an account, the customer 140 can provide a third-party email address 185-1A, a third-party phone number 185-1B, a third-party first name 185-1C, a third-party last name 185-1D, a third-party zip code 185-1E, and/or any other information. As another example, the advertisement platform 115 can include a service that allows the customer 140 to view and/or purchase media content. The customer 140 can provide the customer's third-party email address 185-1A, third-party phone number 185-1B, third-party first name 185-1C, third-party last name 185-1D, third-party zip code 185-1E, and/or any other information to the advertisement platform 115 while viewing and/or purchasing media content. The advertisement platform 115 can include any number of different platforms and/or advertisement entities and can obtain the third-party user information attributes 185-1 in any of a plurality of scenarios. A person of ordinary skill in the art would understand that the examples provided herein are just a few of the possible scenarios.

It should be noted that the customer 140 can independently provide different user information attributes 180-1, 185-1 to the merchant 110 and the advertisement platform 115. For example, the customer 140 can provide a junk first-party email address 180-1A, phone number 180-1B, first name 180-1C, last name 180-1D, or zip code 180-1E to the merchant 110 in order to receive an incentive without receiving merchant promotions. As another example, the customer 140 can provide a fake third-party email address 185-1A to the advertisement platform 115 to anonymously sign up with the advertisement platform 115. The customer 140 can provide any combination of fake, real, or junk information to one or both of the merchant 110 and the advertisement platform 115 without nullifying the effectiveness of the communication technique 160.

The merchant 110 can generate a first-party identified user profile 170 based on the user information attributes 180-1 (e.g., whether real or fake) obtained for the customer 140. The first-party identified user profile 170 can be a collection of first-party user information attributes 180-1 collected for the customer 140. The collection of first-party user information attributes 180-1 can include a plurality of units of information provided by the customer 140 to the merchant 110 that bear at least some measure of uniqueness. The merchant 110 can create a respective first-party identified user profile for each of a plurality of customers and/or potential customers that have provided uniquely identifiable information (e.g., user information attributes 180-1) to the merchant 110.

The advertisement platform 115 can generate a third-party identified user profile 175 based on the user information attributes 185-1 (e.g., whether real or fake) obtained for the customer 140. The third-party identified user profile 175 can be a collection of third-party user information attributes 185-1 collected for the customer 140. The collection of third-party user information attributes 185-1 can include a plurality of units of information provided by the customer 140 to the advertisement platform 115 that bear at least some measure of uniqueness. The advertisement platform 115 can create a respective third-party identified user profile for each of a plurality of users (such as the customer 140) that have provided uniquely identifiable information (e.g., user information attributes 185-1) to the advertisement platform 115.

The merchant 110 can obtain first-party information for a first-party identified user profile 170 that corresponds to the customer 140. The first-party information can include customer insight data and product information collected by the merchant 110 from the customer 140 during the course of developing, selling, and/or providing maintenance for products to a number of customers. The customer insight data for the customer 140, for example, can include profile information such as one or more account preferences, transactional information such as transaction records between the customer 140 and the merchant 110, product preferences/interests exhibited by the customer 140 to the merchant 110 (e.g., through customer service requests, etc.), interaction data descriptive of physical interactions (e.g., recorded by sensors within a store associated with the merchant 110, as described further elsewhere in the instant disclosure) between the customer 140 and a product offered by the merchant 110, and/or any other information associated with and obtained firsthand from the customer 140. By way of example, the customer 140 can request information for a particular product from the merchant 110 through a merchant website 130, by emailing the merchant 110, calling the merchant 110, and/or otherwise interacting with the merchant 110. The merchant 110 can record this information (e.g., the customer's interest in the particular product) as customer insight data.

The merchant 110 can generate a payload 190 for the first-party identified user profile 170 corresponding to the customer 140. The payload 190 can include information (and/or insights thereof) for the customer 140 that enables the advertisement platform 115 to provide a personalized advertisement 155 to the customer 140. For instance, the payload 190 can include at least a portion of customer insight data collected for the customer 140. The payload 190, for example, can be indicative of a product interest level, a recently purchased product, a likelihood to purchase a product from the merchant 110, and/or any other information for personalizing the advertisement 155 for the customer 140. As one example, the payload 190 can include an insight for the customer 140 that indicates that the customer 140 has an interest in purchasing the particular product from the merchant 110. In such a case, the personalized advertisement 155 can include information associated with the particular product (e.g., a running shoe) and/or products associated with the particular product (e.g., running socks, water bottles, etc.). As described in further detail herein, in some implementations, the merchant 110 can utilize one or more tools of a market intelligence service to determine one or more customer insights for the customer 140 based on contextual information. These and other insights can be provided as payloads to the advertisement platform 115.

The merchant 110 can send the payload 190 associated with the customer 140 to the advertisement platform 115 along with information for inferring a third-party identity of the customer 140 (e.g., if the advertisement platform 115 is already associated with the customer 140). The information, for example, can include one or more independently hashed user information attributes 180-2 of the first-party identified user profile 170 corresponding to the customer 140. The one or more independently hashed user information attributes 180-2 can be created by hashing one or more of the user information attributes 180-1 according to one or more standards provided by an orchestration service 165.

The orchestration service 165, for example, can be an entity that develops and distributes communication standards for the privacy conscious delivery of information between two parties such as the merchant 110 and the advertisement platform 115. In some implementations, the orchestration service 165 can be provided by the merchant 110 and/or the advertisement platform 115. For instance, the merchant 110 and/or advertisement platform 115 can develop secure communication standards and provide the standards to the other party. In addition, or alternatively, the orchestration service 165 can be an intermediate platform such as a marketing intelligence platform and/or any other entity unaffiliated with the merchant 110 and the advertisement platform 115. In such a case, the orchestration service 165 can develop and provide communication standards to both the merchant 110 and the advertisement platform 115.

The communication standards for the privacy conscious delivery and interpretation of information by two entities can include one or more cryptographic techniques and/or messaging formats. The cryptographic techniques, for example, can include applying a particular hash function to one or more of the user information attributes 180-1, 185-1 available for the customer 140. Such a hashing technique can provide that each user information attribute is hashed individually in some examples, not in combinations. The orchestration service 165 can determine standards that identify which user information attributes 180-1, 185-1 to individually hash and a particular cryptographic hash function to apply to each of the determined user information attributes 180-1, 185-1. In addition, or alternatively, the standards can define a messaging format that identifies an order in which to communicate first-party hashed user information attributes 180-2 and/or one or more spacing, tagging, etc. rules for communicating the first-party hashed user information attributes 180-2. The messaging format, for example, can enable a recipient of a communication including multiple first-party hashed user information attributes 180-2 to identify where a particular hashed user information attribute is located (e.g., where the hash begins and/or ends, etc.) within the communication. The orchestration service 165 can provide the communication standards for the privacy conscious delivery and interpretation of information to both the merchant 110 and the advertisement platform 115.

The orchestration service 165 can develop the communication standards by determining and/or selecting a particular hash function to apply to each of the user information attributes 180-1, 185-1. The hash function can include any type of hashing algorithm such as, for example, at least one of a message digest algorithm (e.g., MD5), secure hash algorithm (e.g., SHA-0, SHA-1, SHA-2, etc.), etc. As one particular example, the orchestration service 165 can determine and/or select SHA-1 as the hash function. In some implementations, the hash function can be selected from a predetermined list of hash functions (e.g., including SHA-1, etc.). The hash function can take a user information attribute 180-1, 185-1 (e.g., a message) as an input and produce a fixed length hashed value 180-2, 185-2 (e.g., a digest). The resulting hashed user information attribute 180-2, 185-2, for example, can include a 20 byte value represented as a hexadecimal, forty digit long number. The hash function can produce a distinct hash value for each unique input. In this way, the same input to a selected hash function can consistently result in the same hash output.

The orchestration service 165 can provide the hash function to each of the merchant 110 and the advertisement platform 115. In some implementations, the orchestration service 165 can periodically change the hash function. For example, the orchestration service 165 can determine (and/or select from predetermined list of hash functions) a new hash function at a predetermined time interval (e.g., one or more minutes, hours, days, weeks, etc.). In some implementations, the orchestration service 165 can dynamically determine the hash function based on one or more factors. For example, the orchestration service 165 can determine a new hash function in response to the detection of a lack of security of a particular hash function, etc. The orchestration service 165 can provide the determined hash function to each of the parties (merchant 110, advertisement platform 115) each time a new hash function is determined. In addition, or alternatively, the orchestration service 165 can provide a timetable and/or other standard for allowing the merchant 110 and/or advertisement platform 115 to determine the particular hash function to use based on the time, day, and/or any other factors. As still another alternative that is within the scope of the present teachings, the orchestration service 165 can perform the actual hashing operation itself as a hashing service provided to clients such as the merchant 110 and/or the advertisement platform 115. By receiving unhashed data elements from the clients and sending back the hashed versions thereof in real time, the orchestration service 165 could avoid any need for sharing the nature or parameters of the hashing function, keeping the overall system that much more secure.

In some implementations, the orchestration service 165 can identify one or more types of user information attributes 180-1, 185-1 to hash and/or a confidence level associated with each of the identified user information attribute types. For instance, the orchestration service 165 can identify a subset of the available user information attributes for the customer 140 to hash. The subset of the available user information attributes can include, for example, an email user information attribute 180-1A, 185-1A, a phone number user information attribute 180-1B, 185-1B, a first name user information attribute 180-1C, 185-1C, a last name user information attribute 180-1D, 185-1D, and/or a zip code user information attribute 180-1E, 185-1E. Other examples can include an IP address, a billing address, a username, a credit card number, and/or any other attribute that can uniquely identify a person (and/or entity) such as the customer 140.

The orchestration service 165 can determine and/or assign a confidence level associated with each of the identified user information attribute types. The confidence level can be a measure of the uniqueness of a particular user information attribute type. For instance, an email user information attribute 180-1A, 185-1A can include a distinct email address typically associated with a single user (e.g., owner) and can therefore be assigned a high confidence level (e.g., 90% confidence of uniquely identifying the customer 140). A phone number user information attribute 180-1B, 185-1B can also include a distinct number typically only associated with a single user; however, historical data may indicate that a phone number user information attribute 180-1B, 185-1B has a higher likelihood of being fake relative to an email address user information attribute 180-1A, 185-1A. Accordingly, the orchestration service 165 can assign the phone number 180-1B, 185-1B a high confidence level (e.g., 85% confidence of uniquely identifying the customer 140) that is lower than the confidence level assigned to the email user information attribute 180-1A, 185-1A. As another example, a first name user information attribute 180-1C, 185-1C, a last name user information attribute 180-1D, 185-1D, and/or a zip code user information attribute 180-1E, 180-1E can be associated with multiple different individuals and therefore offer a low probability of uniquely identifying the customer 140 by themselves. However, a combination of the three 180-1C-E, 185-1C-E can increase the chances of uniquely identifying the customer 140. Therefore, the orchestration service 165 can assign a low confidence level (e.g., a 20% confidence of uniquely identifying the customer 140) to each individual user information attribute 180-1C-E, 185-1C-E and medium confidence level (e.g., a 60% confidence of uniquely identifying the customer 140) to a combination of the user information attributes 180-1C-E, 185-1C-E.

The orchestration service 165 can provide an indication of which user information attribute types to hash and/or the confidence levels associated with each of the indicated user information attribute types to each of the merchant 110 and the advertisement platform 115. In some implementations, the orchestration service 165 can periodically change the identified user information attribute types and/or confidence levels thereof. For example, the orchestration service 165 can determine a new subset of user information attribute types at a predetermined time interval (e.g., one or more minutes, hours, days, weeks, etc.). In some implementations, the orchestration service 165 can dynamically determine the new subset of user information attribute types based on one or more factors. For example, the orchestration service 165 can identify a new set of user information attribute types and/or adjust confidence levels corresponding to the subset of user information attribute types in response to the detection of a lack of security, reliability, etc. of a particular user information attribute type (e.g., based on historical data, real-time data, etc.). The orchestration service 165 can provide an indication of the new subset of user information attribute types to each of the parties (e.g., merchant 110, advertisement platform 115) each time the subset of user information attribute types are updated. In addition, or alternatively, the orchestration service 165 can provide a timetable and/or other standard for allowing the merchant 110 and/or advertisement platform 115 to determine the subset of user information attribute types to hash based on the time, day, and/or any other factor.

The merchant 110 can generate first-party hashed user information attributes 180-2 for each of the user information attributes 180-1 of the first-party identified user profile 170 corresponding to the customer 140 in accordance with the standards provided by the orchestration service 165. For instance, the merchant 110 can apply the hash function (e.g., determined by the orchestration service 165) individually to each of the user information attributes 180-1 (e.g., of a type indicated by the orchestration service 165) collected for the customer 140 to generate a respective first-party hashed user information attribute 180-2 corresponding to each of the user information attributes 180-1. The merchant 110 can store the resulting first-party hashed user information attributes 180-2 in the first-party identified user profile 170 such that the first-party identified user profile 170 can include a collection of first-party hashed user information attributes 180-2 for the customer 140. In addition, or alternatively, the merchant 110 can dynamically generate the first-party hashed user information attributes 180-2 each time a communication for a third-party is created. The merchant 110 can send the one or more first-party hashed user information attributes 180-2 (e.g., newly generated, or previously stored) to the advertisement platform 115 along with the payload 190.

The advertisement platform 115 can receive the first-party hashed user information attributes 180-2 from the merchant 110 and attempt to match the first-party hashed user information attributes 180-2. For example, the advertisement platform 115 can independently hash (e.g., using the hash function determined by the orchestration service 165) each of a plurality of user information attributes (e.g., of a type indicated by the orchestration service 165, etc.) available to the advertisement platform 115 for each of a plurality of users associated with the advertisement platform 115. In the event that the customer 140 is independently affiliated with the advertisement platform 115, at least one of the user information attributes available to the advertisement platform 115 can correspond to the customer 140. The advertisement platform 115 can compare (e.g., using a text matching function, etc.) the indecipherable text of each of the first-party hashed user information attributes 180-2 received from the merchant 110 to the indecipherable text of each of the third-party hashed user information attributes 185-2 generated by the advertisement platform 115 to determine whether the advertisement platform 115 has access to a third-party hashed user information attribute 185-2 that matches (e.g., includes indecipherable text that matches) a first-party hashed user information attribute 180-2 received from the merchant 110.

By way of example, the advertisement platform 115 can generate third-party hashed user information attributes 185-2 for each of the user information attributes 185-1 of a plurality of third-party identified user profiles (e.g., including the third-party identified user profile 175 corresponding to the customer 140) in accordance with the standards provided by the orchestration service 165. For instance, the advertisement platform 115 can apply the hash function (e.g., determined by the orchestration service 165) individually to each of the user information attributes 185-1 (e.g., of a type indicated by the orchestration service 165) collected for each of the third-party identified user profiles to generate a respective third-party hashed user information attribute 185-2 corresponding to each third-party user information attribute 185-1. The advertisement platform 115 can store the resulting third-party hashed user information attributes 185-2 in a respective third-party identified user profile such that each third-party identified user profile (e.g., the third-party identified user profile 175) can include a collection of third-party hashed user information attributes 185-2 corresponding to a collection of third-party user information attributes 185-1 obtained from a respective user (e.g., the customer 140). In some implementations, the advertisement platform 115 can generate the third-party hashed user information attributes 185-2 for a respective third-party identified user profile 175 in response to receiving a communication including first-party hashed user information attributes 180-2.

The advertisement platform 115 can access a third-party identified user profile 175 for the customer 140 to determine whether at least one third-party hashed user information attribute 185-2 generated by the advertisement platform 115 matches a first-party hashed user information attribute 180-2 received from the merchant 110. The at least one third-party hashed user information attribute 185-2 can match the first-party hashed user information attribute 180-2 in the event that the indecipherable text of the at least one third-party hashed user information attribute 185-2 exactly matches the indecipherable text of the first-party hashed user information attribute 180-2. A partial match (e.g., matches between one or more but not all of the received first-party hashed user information attributes 180-2) can be sufficient to determine that the third-party identified user profile 175 for the customer 140 corresponds to a respective communication. For example, the third-party identified user profile 175 for the customer 140 can be determined to correspond to a communication even if a match is found for only one of a plurality of received first-party hashed user information attributes 180-2.

By way of example, the advertisement platform 115 can determine a set of hashed pairs. Each hashed pair of the set of hashed pairs can include a third-party hashed user information attribute 185-2 (e.g., generated by the advertisement platform 115) and a matching first-party hashed user information attribute 180-2 (e.g., received from the merchant 110). The matching first-party hashed user information attribute 180-2 of a hashed pair, for example, can include the exact same indecipherable text as the matching third-party hashed user information attribute 185-1. The advertisement platform 115 can determine whether a third-party identified user profile 175 for the customer 140 corresponds to a communication received from the merchant 110 based on the set of hashed pairs. For example, the advertisement platform 115 can determine that the third-party identified user profile 175 corresponds to a communication based on the particular user information attribute corresponding to each of the hashed pairs that are included in the set of hashed pairs. For instance, the advertisement platform 115 can determine the particular user information attribute 180-1, 185-1 corresponding to a respective hashed pair by identifying the input 185-1 used by the advertisement platform 115 to generate the third-party hashed user information attribute 185-2 of the respective hashed pair. In addition, or alternatively, the particular user information attribute 180-1, 185-1 can be determined by a position, spacing, and/or tag associated with the first-party hashed user information attribute 180-2 of the respective hashed pair (e.g., if provided for by the orchestration service 165).

In some implementations, the advertisement platform 115 can determine that the third-party identified user profile 175 corresponds to a communication based, at least in part, on a confidence level associated with the set of hashed pairs. For example, the advertisement platform 115 can identify each user information attribute 180-1, 185-1 corresponding to the set of hashed pairs. The advertisement platform 115 can determine a confidence level for the set of hashed pairs based on the confidence levels associated with each identified user information attribute 180-1, 185-1 (e.g., as provided for by the orchestration service 165). By way of example, the advertisement platform 115 can determine an aggregate confidence level for the set of hashed pairs by taking the maximum, average, minimum, median, etc. confidence level for each of the user information attributes 180-1, 185-1 corresponding to the set of hashed pairs. The advertisement platform 115 can determine that the third-party identified user profile 175 of the customer 140 corresponds to a communication from the merchant 110 in the event that the aggregate confidence level for the set of hashed pairs achieves a threshold confidence level (e.g., 50%, 75%, etc.).

In addition, or alternatively, the third-party identified user profile 175 for the customer 140 can be determined to correspond to the communication in the event that the set of hashed pairs include one or more allowed matches (e.g., as provided for by the orchestration service 165). By way of example, the orchestration service 165 can determine one or more allowed matches indicative of possible combinations of matching user information attributes 180-1, 185-1 sufficient to infer the identity of a unique individual (e.g., the customer 140). As one example, the allowed matches can include at least one of a primary match, a secondary match, and/or a tertiary match. The primary match can be indicative of matching email addresses 180-1A, 185-1A. The secondary match can be indicative of matching phone numbers 180-1B, 185-1B. The tertiary match can be indicative of a combination of matching first names 180-1C, 185-1C, matching last names 180-1D, 185-1D, and matching zip codes 180-1E, 185-1E. In this manner, a partial match (e.g., between only a subset of the available user information attributes) can be sufficient for the advertisement platform 115 to determine that the third-party identified user profile 175 for the customer 140 corresponds to the communication from the merchant 110.

For example, the merchant 110 can provide first-party hashed user information attributes 180-2A-E corresponding to a first-party email 180-1A, a first-party phone number 180-1B, a first-party first name 180-1C, a first-party last name 180-1D, and a first-party zip code 180-1E for the customer 140 to the advertisement platform 115. The advertisement platform 115 may independently have access to a third-party email address 185-1A, a third-party phone number 185-1B, a third-party first name 185-1C, and a third-party last name 185-1D for the customer 140. The advertisement platform 115 may not have access to a third-party zip code 185-1E. The advertisement platform 115 can generate third-party hashed information attributes 185-2A-D for the third-party email address 185-1A, the third-party phone number 185-1B, the third-party first name 185-1C, and the third-party last name 185-1D for the customer 140. In this example, the advertisement platform 115 does not have access to a third-party zip code 185-1E for the customer 140 and therefore can be unable to generate a hashed third-party zip code 185-2E.

The advertisement platform 115 can determine a set of hashed pairs, in the manner described herein, based on the first-party hashed user information attributes 180-2A-E received from the merchant 110. The set of hashed pairs can include a hashed pair corresponding to the third-party phone number 185-1B (e.g., including a matching first-party hashed phone number 180-2B and a third-party hashed phone number 185-2B), the third-party first name 185-1C (e.g., including a matching first-party hashed first name 180-2C and a third-party hashed first name 185-2C), and the third-party last name 185-1D (e.g., including a matching first-party hashed last name 180-2D and a third-party hashed last name 185-2D).

For instance, the customer 140 may have given a first-party email address 180-1A to the merchant 110 that is different than the third-party email address 185-1A given to the advertisement platform 115 causing the first-party hashed user information attribute 180-2A corresponding the first-party email address 180-1A to differ from the third-party hashed user information attribute 185-2A generated for the third-party email address 185-1A. In addition, or alternatively, the customer 140 may never provide a third-party zip code 185-1E to the advertisement platform 115 causing the advertisement platform 115 to fail to find a third-party hashed user information attribute 185-2E matching the first-party hashed user information attribute 180-2E corresponding to the first-party zip code 180-1E.

The advertisement platform 115 can determine that the set of hashed pairs include a secondary match (e.g., matching hashed phone numbers 180-2B, 185-2B) associated with a third-party information attribute, phone number 185-1B, of the third-party identified user profile 175. The advertisement platform 115 can determine that the third-party identified user profile 175 for the customer 140 corresponds to the communication from the merchant 110 based on the secondary match regardless of whether a match is found for the other hashed user information attributes 180-2A, -2C, -2D, -2E provided by the merchant 110.

As described herein, the third-party identified user profile 175 can include a collection of third-party user information attributes 185-1 (and/or corresponding third-party hashed user information attributes 185-2) collected for the customer 140. The collection of third-party user information attributes 185-1 can include the user information attributes 185-1 for the customer 140 that are independently available to the advertisement platform 115. For example, the third-party identified user profile 175 can include a username (and/or other profile information) for the customer 140 that uniquely identifies the customer 140 to the advertisement platform 115. In addition, or alternatively, the third-party identified user profile 175 can include device information independently provided to the advertisement platform 115 by the customer 140. In this manner, the advertisement platform 115 can associate the payload 190 provided by the merchant 110 with the customer 140 by inferring the customer's identity from hashed, indecipherable, customer information.

In some implementations, the advertisement platform 115 can add the unmatched first-party hashed user information attributes 180-2A, 180-2E to the third-party identified user profile 175. For example, the advertisement platform 115 can store each of the first-party hashed user information attributes 180-2A-E received from the merchant 110 to later match the third-party identified user profile 175 (and thereby infer the customer's identity) (e.g., until the hash function and/or user information attribute types are updated) to a communication provided by the merchant 110. In some implementations, the advertisement platform 115 can identify a user information attribute type associated with each unmatched first-party hashed user information attribute 180-2A, 180-2E based on one or more messaging formats identified by the orchestration service 165. It should be noted that, even in this scenario, the advertisement platform 115 would still be unable to identify the actual user information attribute of an unmatched hashed user information attribute.

The advertisement platform 115 can leverage the payload 190 provided by the merchant 110 to generate a personalized advertisement 155 for the customer 140 corresponding to the third-party identified user profile 175. In this way, a personalized advertisement 155 can be generated for the customer 140 by the advertisement platform 115 based on information (and/or insights thereof) collected by the merchant 110. The personalized advertisement 155, for example, can include information associated with the merchant 110, a product offered by the merchant 110 that the customer 140 has expressed interest in, etc. For example, the personalized advertisement 155 can include information for the particular product that the customer 140 expressed interest in through the merchant website 130, by emailing the merchant 110, calling the merchant 110, and/or otherwise interacting with the merchant 110. The personalized advertisement 155 can be provided to the customer 140 using one or more channels, platforms, etc. associated with the advertisement platform 115.

In this manner, the merchant 110 can determine and securely distribute insights (e.g., payloads 190) for the customer 140 without the use of cookies or other digital signals that track a customer's internet activity. Moreover, identifiable information (e.g., user information attributes 180-1) for the customer 140 can be hashed before distribution of customer information; thereby, preventing malicious parties or unaffiliated third parties from identifying the customer 140 associated with a respective insight. In this regard, each hashed user information attribute distributed to a third-party can include an indecipherable string of variables such that the recipient of a respective hashed user information attribute will be unable to use the hashed user information attribute to discover the user information attribute corresponding to the hash. Ultimately, this prevents the recipient from identifying the customer 140 referenced by the respective hashed user information attribute.

As discussed, in further detail herein, the merchant 110 can use the communication techniques 160 to hash individual user information attributes corresponding to a plurality of different customers associated with respective customer insight data (e.g., an interest in a similar product, etc.). In such a case, the merchant 110 can send one or more payload(s) 190 (e.g., with a portion of customer insight data for a respective insight) to the advertisement platform 115 along with a plurality of first-party hashed user information attributes (e.g., at least a first hashed user information attribute of a first first-party identified user profile and a second hashed user information attribute of a second first-party identified user profile) associated with the plurality of customers. The advertisement platform 115 can determine respective third-party identified user profiles corresponding to the communication based on the plurality of first-party hashed user information attributes (e.g., by matching indecipherable text of the respective first-party hashed user information attributes to the indecipherable text of respective third-party hashed user information attributes associated with the respective third-party identified user profiles) in the event that one or more of the plurality of customers that have independently provided a matching user information attribute to the advertisement platform 115. In this way, the merchant 110 can orchestrate group advertisement campaigns across a number of different advertisement platforms (e.g., including the advertisement platform 115) without disclosing its customer's private information.

While having other advantages relating to privacy and the elimination of third-party cookies, one particularly useful advantage of the communication technique 160 can be found in the ability for the advertisement platform 115 to provide potentially meaningful advertising content (e.g., personalized advertisement 155) even in extremely information-poor circumstances, where very little personally identifying information about the customer 140 is known or even cared about. The communication technique 160 can be thought of as a payload-centric, rather than an identity-centric, method for serving useful advertisements 155 by the advertisement platform 115. Provided only that there is enough information to associate the customer 140 with one or more previous payloads characterizing some particular action, trait, event, interest, etc., the advertisement platform 115 can still provide a meaningful advertisement 155 without ever needing to determine who the customer 140 actually is.

In this regard, FIG. 1C depicts an example application of the communication technique 160 for providing an advertisement 155 is an information-poor circumstance according to example aspects of the present disclosure. As depicted, the customer 140 can interact with a secondary website 135 (e.g., through web browser 150 or any other web browser) affiliated with the advertisement platform 115. During the course of the customer's interaction with the secondary website 135, the customer 140 can provide an email 195-1. By way of example, the secondary website 135 can offer access to a one-time online music concert (e.g., produced by the advertisement platform 115, an entity associated with the secondary website, etc.) in exchange for the customer's email address 195-1. Like many others, the customer 140 can keep a junk e-mail address for this purpose and provides that junk e-mail address (or a real email address) to watch the concert. Meanwhile, customer 140 may have visited the merchant 110 (e.g., merchant website 130, a physical location of the merchant, etc.) in the past and used the same email address 195-1 (e.g., a junk, real, etc. e-mail address), for example, to access a printable coupon for a particular shoe offered by the merchant 110. In some cases, the customer 140 can have provided no other information.

Even in this information-poor circumstance, the merchant 110 may provide a payload 190A with a hashed email 180-2A (e.g., hashed version of the coupon-printer's junk/real e-mail address) to the advertisement platform 115 that indicated an interest in the particular shoe. In some cases, the advertisement platform 115 can, in turn, match the hashed email address 180-2A received from the merchant 110 with another hashed email address 185-2A generated by the advertisement platform 115 based on emails provided by a number of users associated with advertisement platform 115. Regardless of whether a match is found the advertisement platform 115 can store the hashed email 180-2A received from the merchant 110 in association with the payload 190A and, in the case of matching the hashed email 180-2A with another hashed email 185-2A, previous payloads obtained for the customer 140 (or another person associated with the email 195-1).

The secondary website 135 can receive the email address 195-1 and hash the email address 195-1 to generate the hashed email address 195-2. For example, the advertisement platform 115 or another entity such as the merchant 110, the orchestration service 165, etc. can provide data indicative of the communication standards for hashing the email address 195-1 to the secondary website 135. As an example, the advertisement platform 115 can provide computer-implemented code (e.g., JavaScript, etc.) that can be executed by the secondary website 135 upon receipt of the email address 135. The code can automatically apply the hashing function to the email 195-1 to generate the hashed email 195-2 and forward the hashed email 195-2 to the advertisement platform 115 with a request for information to render a personalized advertisement such as advertisement 155. The advertisement platform 115 can, in turn, match the received hash 195-2 with their hash 185-2A of the customer's email 195-1 (e.g., junk, real, etc. e-mail address). An association between that customer 140 (e.g., a particular one-time concert-watching user) and the payload 190B (e.g., that the customer 140 likes a particular shoe) can be established, and a meaningful advertisement 155 can be provided for rendering through the secondary website 135 to the customer (e.g., the particular concert-watching user during the one-time music concert), without the advertising platform 115 or the secondary website 135 ever learning anything about the customer 140 except the customer's e-mail address 195-1. Meanwhile, no cookies were used, and furthermore, if the communication (e.g., between the merchant 110 to the advertisement platform 115 or the advertisement platform to the secondary website 135) carrying the particular shoe-related payload and hashed coupon-printing customer's information were intercepted by a rogue party, the information would be useless in determining any identifying information, even the junk e-mail address 195-1 of the customer 140.

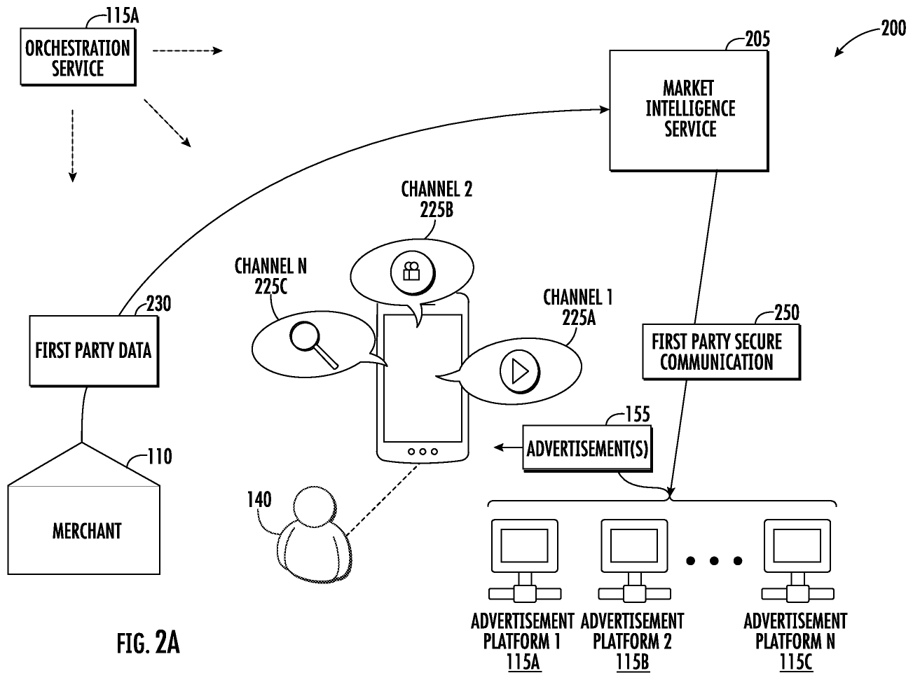

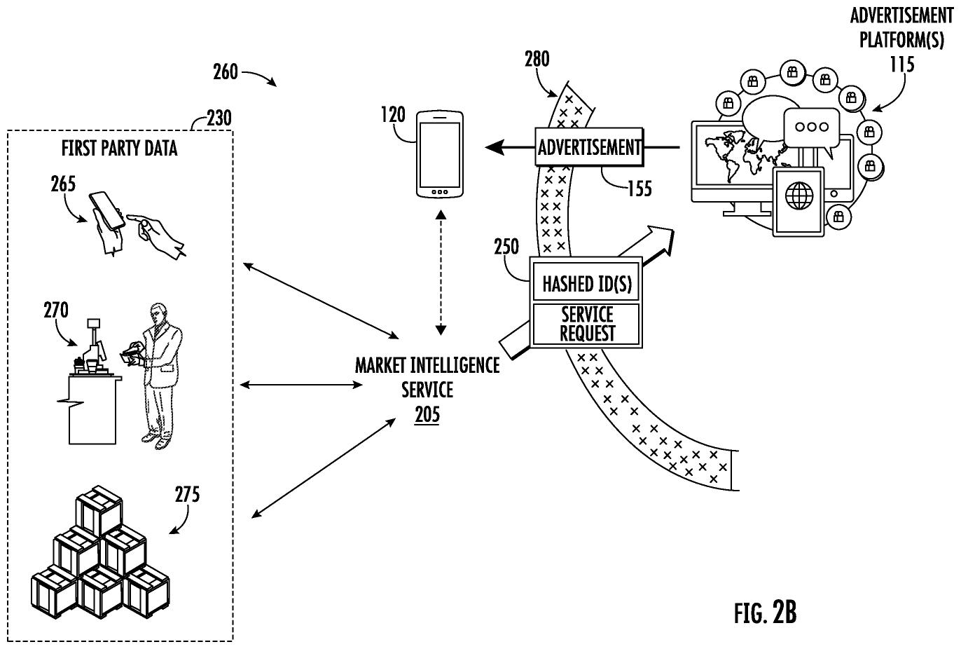

FIG. 2A depicts a secure, multi-platform marketing system 200 according to example aspects of the present disclosure. The multi-platform marketing system 200 includes a market intelligence service 205 that can act as an intermediary between merchant 110 that interacts with customers to sell products and third-party platforms such as, for example, advertisement platforms 115A-C that interact with users to advertise products for the merchant 110. Merchant 110 can gather valuable customer information during the course of developing, selling, and providing maintenance for products to a number of customers. This “first-party information” can include transaction records, inventory/supply chain information, customer preferences (e.g., from customer service experiences, etc.) and other information gained through the production and distribution of different products. First-party information can be leveraged to make informed product and marketing decisions including decisions to market different products to different customers. However, merchants 110 typically do not have access to advertisement tools, such as advertising platforms/channels 225A-D (e.g., media channel(s) 225A, social media channel(s) 225B, search browser interface(s) 225D, etc.), useful for facilitating sophisticated advertising campaigns.

Instead, merchants 110 with access to valuable customer information rely on third-party advertising platforms 115A-C to inform customers such as customer 140 of their products. Third-party advertising platforms 115A-C typically do not sell products to customers and thus do not have access to customer information. Customer information includes intimate details for customers that are private to each respective customer. Therefore, the merchant 110 may be reluctant to provide customer information to third-party advertising platforms 115A-C due to concerns with revealing private information of its customers to third parties, otherwise unaffiliated with respective customers. Moreover, if communicated without taking proper security measures, communications with intimate details for a respective customer (e.g., customer 140) could be intercepted by malicious parties allowing unintended recipients of a communication to gain personal insights for the respective customer. As a result, third-party advertising platforms 115A-C such as platform services, advertising agencies, etc. are forced to gain insights for their users through other means.

A traditional prevalent means for third-party advertising platforms 115A-C to generate insights for users is through the collection and analysis of digital signals such as those collected by third-party cookies as described herein with reference to FIG. 1A. Digital signals describe digital interactions between the customer 140 (e.g., user device 120) and a platform, service, or advertisement (e.g., content provided to a user) offered by a third-party. The digital signals can be descriptive of a user clicking on an advertisement, browsing for different products, or any other digital activity associated with a user's interests. These signals can be recorded by internet cookies (e.g., software packets downloaded through a search browser). Cookies can be designed to record digital signals and store information associated with the digital signals on the user device 120 such that the information can be accessed by advertising platforms 115A-C for generating insights for their users. Cookies, and digital signals, can be unreliable and provide different insights for the customer 140 across different channels 125A-C. Thus, cookie based advertisements generated by different advertising platforms 115A-C can be inconsistent and, in some cases, irrelevant for the customer.

The market intelligence service 205 described herein empowers the merchant 110 to determine insights for its customers based on first-party information gathered directly from its customers and provide those insights to third-party advertising platforms 115A-C (e.g., using communication standards developed by the orchestration service 165, etc.) for marketing campaigns in a “cookie-less,” secure, privacy conscious manner. The market intelligence service 205 enables privacy conscious marketer-to-advertiser communications 130 by providing tools to the merchant 110 for generating customer insights based on first-party information, thereby enabling the merchant 110 to provide valuable information derived from first-party information without directly communicating first-party information to a third-party.

The market intelligence service 205 can provide for the secure communication techniques described herein for referencing customers in a manner that prevents a third-party from referencing customers with which it is not already affiliated. Marketing intelligence service 205 may be implemented by merchant 110 in some examples, such as by one or more computing devices operating by the merchant. In another example, marketing intelligence service 205 can be implemented by another party, such as orchestration service 165. For instance, the market intelligence service 205 can include the orchestration service 165. In addition, or alternatively, the market intelligence service 205 can communicate with the orchestration service 165 to obtain privacy secure communication standards described herein. The privacy secure communication standards, in combination with the platform tools of the market intelligence service, can enable the merchant to reference customers through irreversibly hashed groups. The hashed groups can be created by hashing personal identifiers associated with the respective customers that are accessible to the merchant 110. Each hashed group can include a dataset of indecipherable variables such that the recipient of a secure communication 250 including a hashed group (whether that recipient is the intended recipient or a malicious intercepting party) will be unable to identify customers referenced by the group of hashed identifiers. Upon receiving the secure communication 250 with a group of hashed identifiers, a third-party advertisement platform 115A-C can determine whether any of its users are referenced by the hashed group by applying the same hash function (as prescribed by the secure communication standards of the orchestration service 165) used to create the hashed group to a number of identifiers corresponding to each of the third-party's users. The third-party advertisement platforms 115A-C can determine that a respective user is referenced by the message 250 by matching a respective hashed user identifier with an individual hashed user identifier included in the hashed group of identifiers. In this way, insights for a customer can be sent to a number of parties, but only deciphered by those parties that independently received a user identifier corresponding to a customer identifier hashed by the merchant 110. This allows a first-party merchant to orchestrate coordinated and personalized messaging campaigns for its customers (or potential customers) across a number of different third-party platforms 115A-C and advertising channels 125A-C without exposing intimate details entrusted to it by its customers (or potential customers).

In this regard, the market intelligence service 205 can provide a merchant 110 with tools for generating customer insights based on first-party information collected by merchant 110. The tools can be used for inventory awareness, customer awareness, and/or any other self-analysis that can empower the merchant 110 to make decisions on how to message customers, which customers to message, etc. Example tools can include a suite of algorithms (e.g., machine-learning models, etc.) for predicting a customer's lifetime value, predicting a customer's churn rate, predicting a customer's interest in products offered by the merchant 110, or predicting characteristics shared by potential customers. Using tools provided by the market intelligence service 205, a merchant 110 can segment its customers according to a customer value or chum rate, provide relevant product recommendations to customers, provide inventory-aware recommendations to customers, identify potential customers for customer acquisition, etc. The merchant 110 can activate (e.g., act on, etc.) these insights by providing privacy secure service requests 250 to a number of different third-party platforms 115A-C. This can enable the merchant 110 to orchestrate a customer journey for each of its customers by instructing (e.g., through service requests to affiliated third-party platforms) third-party platforms 115A-C to provide consistent, personalized, and relevant advertisements 155 through various channels 125A-C based on insights derived from first-party information.

For example, merchant 110 can collect first-party data 230 (e.g., transaction history, account information, etc.) from a number of first-party users, such as customer 140, that interact with the merchant 110. The information can be stored in a secure server (e.g., a unified data repository of the market intelligence service 205) where machine-learning models can be leveraged to gain insights for the number of first-party users based, at least in part, on the first-party data 230. The first-party users can be grouped into different groups according to insights gained thereof. The merchant 110 can create a secure message 250 that securely references each member of a group of its first-party users by individually hashing a first-party user identifier (e.g., a username, a first/last name, an email, phone number, zip code, etc.) corresponding to each first-party user in the group. The message 250 can be provided to advertising platforms 115A-C with a request to provide an advertisement service on behalf of the merchant 110. The advertising platform 115A-C can create a hashed list including a number of hashed third-party user identifiers corresponding to a number of third-party users, such as the customer 140, affiliated (e.g., has an account with, etc.) with the third-party advertising platform 115A-C. The hashed list can be compared to the hashed first-party user identifiers to reference first-party users within the message 250, such as the customer 140, that are also affiliated with the third-party advertising platforms 115A-C. The advertising platforms 115A-C can perform the requested advertisement service for the merchant 110 based, at least in part, on the referenced users. In this way, a merchant 110 can securely send information across different networks to another party without endangering the privacy of its first-party users. For example, by hashing first-party user identifiers associated with its customers, the merchant 110 can prevent the recipient of the message 250 (e.g., a third-party, an adverse party, etc.) from gaining insights for customers that are not affiliated with the recipient. Meanwhile, affiliated parties such as the third-party advertising platform(s) 115A-C can have the ability to hash the same information as the first-party (e.g., third-party identifiers corresponding to a first-party identifier), thereby enabling affiliated parties to gain insights for first-party users without requiring the merchant 110 to directly disclose the identity of the first-party users. Ultimately, this enables the merchant 110 to determine insights for a number of first-party customers based on first-party information and provide such information to a third-party in a privacy conscious manner.

The technology of the present disclosure can enable merchant 110 and third-party advertiser(s) 115A-C to determine and securely distribute insights without the use of cookies or other digital signals that track a user's internet activity. As described herein, cookies are designed to record digital signals and store information associated with the digital signals on potentially non-secure personal devices such that the information can be accessed by third parties (e.g., for creating personal websites, presenting targeted content, etc.). By way of example, when a user visits a website for the first time, a cookie is created by a web server hosting the site and is sent to a browser used to access the website. This initial cookie includes identifiable information (e.g., a name-value pair) for the user and instructs the browser to record information (e.g., internet activity, transaction activity, etc.) and store the information in a particular location on the user's personal device. When the user later visits the same site, the web browser passes the recorded digital information back to the web server. This information is typically not encrypted and is vulnerable to malicious parties. The technology of the present disclosure provides a more privacy conscious alternative to cookies by leveraging customer information (e.g., information gained by a merchant 110 through interaction with a first-party user such as the customer 140) recorded to a market intelligence service 205. The market intelligence service 205 can enable the merchant 110 to determine and securely distribute insights for users without the use of cookies or other digital signals that track a user's internet activity because it has access to data obtained through an actual interaction with the merchant 110. Moreover, identifiable information for a user of the merchant 110, such as the customer 140, is hashed before distribution; thereby, preventing malicious parties or unaffiliated third parties from accessing user information.

The merchant 110 includes a first-party with firsthand knowledge of a plurality of first-party users (e.g., customers or potential customers of the merchant 110). By way of example, the merchant 110 can include an entity involved in the supply of items or services to one or more first-party users of the merchant's services, products, etc. For example, the merchant 110 can include a product manufacturer, designer, etc. that develops and/or offers for sale one or more products. In addition, or alternatively, the merchant 110 can include a retail establishment offering a plurality of items produced, manufactured, and/or designed by a number of different entities. In some implementations, the merchant 110 can include a service provider that offers one or more services (e.g., landscaping, marketing, etc.) to a plurality of first-party users.

The plurality of first-party users can include customers and/or potential customers of the merchant 110 that purchase products from the merchant 110, use products provided by the merchant 110, subscribe to services offered by the merchant 110, and/or otherwise interact firsthand with the merchant 110. By way of example, the plurality of first-party users can include a number of customers (and/or potential customers) that have purchased, shown interest in purchasing, or are otherwise associated (e.g., via a first-party account, subscription, etc.) with at least one product or service offered by the merchant 110.

First-party data 230 can be collected, maintained, and/or acted upon by the merchant 110 through the market intelligence service 205. The market intelligence service 205, for example, can import first-party data 230 from merchant 110 and/or provide one or more software service(s) for generating insights based on imported information. By way of example, the market intelligence service 205 can offer one or more application programming interfaces (“APIs”) that enable the merchant 110 to securely collect, store, and/or transfer first-party data 230 (and/or one or more insights derived thereof) associated with one or more of its first-party users. As described in further detail herein, the market intelligence service 205 can include a cloud environment hosted by an intermediary cloud computing platform. In addition, or alternatively, the market intelligence service 205 can include a standalone software application running on one or more backend servers associated with the merchant 110.

The first-party data 230 can be analyzed by the merchant 110 using tools provided by the market intelligence service 205. For example, the software tools provided by the market intelligence service 205 can be used to generate customer and/or inventory aware insights based on the first-party data 230. The tools, for example, can include a plurality of predictive machine-learning model(s). In some implementations, the machine-learning model(s) can include one or more deep neural networks. Access to the deep neural networks can be provided through one or more interfaces (e.g., API(s), etc.) associated with the market intelligence service 205.

The merchant 110 can generate one or more user groups based, at least in part, on the first-party data 230. The user groups can include a subset of the plurality of first-party users associated with common attributes that can provide particular insights for a respective subset of first-party users. The common attribute(s) can include common purchase histories, user preferences, etc. with which one or more insights (e.g., a product interest, a value to the merchant 110, etc.) have been (and/or can be) derived. By way of example, the common attribute(s) can be identified through one or more machine-learned model(s) configured to identify correlations between first-party user attributes and corresponding insights.

As one example, the common attribute(s) for a subset of first-party users can be indicative of a common interest level for a respective product. The attribute(s), for example, can include one or more transactional attributes indicative of a transaction associated with a respective product (e.g., a past transaction including the item, a related item, etc.) and at least one respective first-party user. In addition, or alternatively, the common attribute(s) can include contextual attribute(s) indicative of an association between the respective product and at least one respective first-party user of the subset of the plurality of first-party users. The contextual attribute(s), for example, can be descriptive of one or more physical interaction(s) (e.g., picking up a product, analyzing a product, etc. in a brick and mortar store) between the respective product (and/or related product) and the at least one respective first-party user of the subset of the plurality of first-party users. As other examples, the contextual attribute(s) can include user preference(s), demographic information, and/or any other information associating a respective user with a respective product. In some implementations, the common attributes can be identified by a product recommendations engine based, at least in part, on the first-party data.

Information associated with the user groups, the first-party users, and/or insights or common attributes linking the first-party users can be provided to one or more third-party advertising platform(s) 115A-C to enable the third-party platform(s) 115A-C to provide personalized advertisements 155 to third-party users such as, for example, the customer 140. To do so in a privacy conscious manner, the market intelligence service 205 can generate a hashed user group based on a user group and a hashing algorithm (e.g., the hashing algorithm prescribed by the orchestration service 165). The hashed user group can include a hashed list referencing a subset of first-party users within a user group. For instance, the hashed list can include one or more hashed identifiers for each respective user within the user group. The hashed identifiers for each respective user can include at least one of a hashed email, a hashed phone number, and/or a hashed first name, last name, and/or zip code.

The market intelligence service 205 can generate the first-party secure communication 250 for one or more third-party advertising platform(s) 115A-C based, at least in part, on the hashed user group. The first-party secure communication 250 can include and/or otherwise identify the hashed user group. For example, an identification of the user group (e.g., common interest in a particular shoe) can be provided as a payload of communication 250. In addition, the market intelligence service 205 can include one or more service requests for the third-party advertising platform(s) 115A-C.

The third-party advertising platform(s) 115A-C, for example, can be associated with third-party advertising channels 125A-C. The third-party advertising platform(s) 115A-C can be in collaboration with the merchant 110, for example, to advertise one or more products or services offered by the merchant 110 across one or more different advertising channels 125A-C such as, for example, media channels 125A, social media channels 125B, search browser channels 125C, etc. By way of example, the third-party advertising platform(s) 115A-C can be configured to provide advertising services to, for example, acquire customers for the merchant 110, provide personalized messaging to customers of the merchant 110, etc. The first-party secure communication 250 can include a service request to perform one or more service operations for the merchant 110. The service operations, for example, can include a user acquisition operation for acquiring new customers for the merchant 110, a user servicing operation for providing customer specific information to one or more customers of the merchant 110, a product offering operation for providing product specific information to one or more third-party users of the third-party advertising platform(s) 115A-C, and/or merchant 110 informational operations for providing merchant information (e.g., for a respective product, etc.) to one or more third-party users of the third-party advertising platforms 115A-C.

The market intelligence service 205 can communicate the first-party secure communication 250 to the third-party advertising platforms 115A-C. The third-party advertising platforms 115A-C can reference at least one third-party user corresponding to the user group (e.g., using the secure communication standards prescribed by the orchestration service 165). For instance, the third-party advertising platforms 115A-C can compare the hashed user group to third-party data to reference one or more third-party users associated with the first-party secure communication 250 without any prior knowledge of the market intelligence service 205 or the first-party users of the merchant 110. For example, in the event that the same user is affiliated with both the merchant 110 and the third-party advertising platform(s) 115A-C, the third-party data can include third-party user identifiers corresponding to a respective first-party user identifier for the affiliated user. This enables the third-party advertising platform(s) 115A-C to reference an affiliated user of the hashed user group by hashing the same information hashed by the merchant 110 (e.g., corresponding user identifiers) and matching the hashed information to at least a portion of the hashed user group. In this manner, the market intelligence service 205 can securely transmit hashed information associated with its first-party user over one or more networks (e.g., secure, or unsecure) without exposing customer information such as transaction history, value to the merchant 110, etc. to malicious parties.

More particularly, the third-party advertisement platform(s) 115A-C can include and/or be associated with a plurality of third-party users. The third-party users can have an account with and/or otherwise utilize one or more services, platforms, etc. of the third-party advertisement platform(s) 115A-C. For example, the third-party advertisement platform(s) 115A-C can include and/or be associated with an internet browser (e.g., with a search browser marketing channel 125C), a social media platform (e.g., with a social networking marketing channel 125B), a media platform (e.g., with a video marketing channel 125A), an advertising agency, and/or any other interactive interface for engaging with third-party users.

The third-party advertisement platform(s) 115A-C can include and/or have access to third-party user data. The third-party user data can include information associated with the plurality of third-party users. By way of example, the third-party user data can be indicative of a plurality of third-party user accounts associated with the third-party advertisement platform(s) 115A-C. For instance, the third-party user data can include one or more user preferences, user identifiers, activity information, etc. for each of the plurality of third-party users. In some implementations, each of the plurality of third-party user accounts can include one or more user identifiers (e.g., a name, email, phone number, physical address, etc.).

The third-party advertisement platform(s) 115A-C can generate a third-party hashed list based, at least in part, on the third-party user data and a hashing algorithm (e.g., as prescribed by the orchestration service 165). The third-party advertisement platform(s) 115A-C can apply the hashing algorithm to at least one of the one or more user identifiers for each of the plurality of third-party user accounts to generate the third-party hashed list. The third-party hashed list can include a plurality of hashed third-party identifiers corresponding to a plurality of third-party user identifiers. For example, each hashed third-party identifier can correspond to a respective third-party user identifier. Each hashed third-party identifier can reference a respective third-party user based, at least in part, on the corresponding third-party user identifier. The plurality of third-party user identifiers corresponding to the third-party hashed list can at least in part overlap the plurality of first-party user identifiers corresponding to the hashed user group. By way of example, a user affiliated with both the merchant 110 and the third-party advertisement platform(s) 115A-C (e.g., customer 140) can provide at least one of the same user identifiers to each party. This, in turn, enables the third-party advertisement platform(s) 115A-C to hash at least part of the same information used by the market intelligence service 205 as a basis for the hashed user group. The third-party advertisement platform(s) 115A-C can generate a third-party hashed list that at least partially matches the hashed user group by applying the same hash function as the market intelligence service 205 to the at least partially overlapping information used as a basis for the hashed user group. By doing so, the third-party advertisement platform(s) 115A-C can reference a third-party user associated with the hashed group despite the irreversibility of hashed information.

The third-party advertisement platform(s) 115A-C can determine one or more actions to be taken in response to the first-party secure communication 250 based, at least in part, on the list of third-party users determined based on the hashed user group included in the first-party secure communication 250, third-party user data accessible to the advertisement platform(s) 115A-C, and/or the requested service operations of the first-party secure communication 250. For example, the third-party advertisement platform(s) 115A-C can initiate one or more personalized advertisements 155 to the customer 140 based on the secure communication 250. By way of example, the customer 140 can be determined from the hashed user group and the requested service operation can request the provisioning of a personalized advertisement to the customer 140. In such a case, the third-party advertisement platform(s) 115A-C can generate one or more personalized advertisements based, at least in part, on third-party data and/or first-party data provided by the first-party secure communication 250 and provide data indicative of at least one of the one or more advertisements 155 to one or more user device(s) 120 associated with the customer 140.

By way of example, the advertisement 155 can be provided for display to the customer 140 through one or more marketing channels 125A-C accessible to the user device 120. For example, the third-party advertisement platform(s) 115A-C can provide the data indicative of the one or more advertisement 155 for display within a social media platform 125B hosted by the third-party advertisement platform(s) 115A-C. In addition, or alternatively, the third-party advertisement platform(s) 115A-C can receive input data indicative of a website and the customer 140. In such a case, the third-party advertisement platform(s) 115A-C can provide data indicative of a customized website 125C for display to the user based, at least in part, on the third-party data and/or first-party data included in the secure communication 250 for the customer 140. In some implementations, the third-party advertisement platform(s) 115A-C can provide the data indicative of the one or more advertisement 155 for display within a video channel 125A hosted by the third-party advertisement platform(s) 115A-C.

The present disclosure provides a number of technical effects and benefits. For example, the disclosed technology can replace previous techniques of relying on internet cookies to gain insights on users by leveraging first-party data gathered directly from interactions with users. This, in turn, can help save computational resources (e.g., processing, memory, power, etc.) on personal computers that are otherwise wasted observing and storing personal data using conventional techniques such as browser cookies. Moreover, unlike conventional techniques, the present disclosure can enable a first-party to securely store, analyze, and distribute user information in a privacy conscious manner that protects user information from malicious parties or third parties that are unaffiliated with a respective user. This, in turn, allows a first-party to orchestrate consistent messaging campaigns across a plurality of different third-party platforms without endangering the privacy of its users. Ultimately, the technology of the present disclosure provides effective, computationally efficient, and secure data encryption and communication processes, systems, and devices that can be applied in a marketing context.

The present disclosure provides a number of improvements to computing technology such as, for example, storage, encryption, and communication technologies. For instance, the present disclosure describes secure data storage and communication techniques (e.g., using hashed user lists) to provide practical improvements to data security especially relevant in the realm of internet privacy. The present disclosure employs improved collaboration techniques between joint entities that allow a first-party to provide private customer information to another party while preserving the privacy of the information associated with the first-party's customers. To do so, the systems and methods described herein accumulate and distribute newly available information such as, for example, hashed lists of customer identifiers, etc. that can only be used to reference users that are affiliated with a recipient party. By leveraging such data, the system and methods described herein can generate secure communications between a first and third-party. In this manner, the present disclosure enables privacy conscious market collaboration while preserving the privacy of user information over the internet.

In some implementations, in order to obtain the benefits of the techniques described herein, the user may be required to allow the collection and analysis of sensor data associated with the user or their device. For example, in some implementations, users may be provided with an opportunity to control whether programs or features collect such information. If the user does not allow collection and use of such signals, then the user may not receive the benefits of the techniques described herein. The user can also be provided with tools to revoke or modify consent. In addition, certain information or data can be treated in one or more ways before it is stored or used, so that personally identifiable information is removed. As an example, a computing system can obtain sensor data which can indicate a scan, without identifying any particular user(s) or particular user computing device(s).

FIG. 2B depicts an example marketing environment 260 according to example aspects of the present disclosure. The marketing environment 260 includes the market intelligence service 205 which acts as an intermediary between a merchant with firsthand knowledge of customer(s) and/or product(s) and advertisement platform(s) 115 that interact with users to advertise products for the merchant. The market intelligence service 205 can be a trusted server that hosts cloud environments for a number of affiliated merchants. In addition, or alternatively, the market intelligence service 205 can be hosted by one or more first-party servers maintained and/or operated by a merchant. For example, operations and/or benefits of the market intelligence service 205 can be performed and/or enabled by a standalone software application executed by one or more first-party device(s).

A respective merchant can create an account with the market intelligence service 205 to access software tools provided by the market intelligence service 205 such as, for example, tools to import customer or product information from various siloed datacenters, tools to generate complex insights for customers based on firsthand information, and/or tools to securely facilitate marketing campaigns across a number of third-party platforms 115. In this way, the market intelligence service 205 can empower merchants to efficiently use valuable first-party information gained through the course of business to facilitate personalized marketing across a number of different platforms without endangering the privacy of their customers.

A merchant gathers valuable first-party data 230 during the course of developing, selling, and providing maintenance for products to a number of customers. This “first-party information” can include first-party user information 265 (e.g., customer preferences, etc.), transactional information 270 (e.g., transaction records, etc.), and/or inventory information 275 (e.g., inventory/supply chain information, etc.). By way of example, the merchant can be associated with a plurality of marketing silos (e.g., dedicated servers, marketing service applications, third-party marketing tools, etc.) configured to obtain, maintain, catalogue, analyze, etc. first-party data 230 gathered by the merchant during the course of business. At least one of the marketing silos can handle first-party user information 265 (e.g., user accounts created for a first-party application hosted by the merchant, etc.). Another (and/or the same) marketing silo can handle transaction information 270. While a further (and/or the same) marketing silo can handle product inventory information 275.

The first-party user information 265 can include customer preferences and/or other customer information gained through interaction with first-party users. As an example, the first-party user information can include information (e.g., preferences, likes, saves, etc.) input to a first-party application hosted by the merchant. As another example, the first-party user information can include information descriptive of customer service requests, product inquiries, product returns, customer reviews, etc. The transactional information 270 can include transactional records and/or other information descriptive of products purchased by a customer such as, for example, a number of products purchased, a frequency of purchases, a monetary value of each purchase, etc. The inventory information 275 can include product availability information such as, for example, an availability of a product at one or more different stores or geographic regions, a production rate/plan for a product, an expected demand for a product, a current demand for a product, etc.

First-party data 230 can be leveraged to make informed production and marketing decisions including decisions to market different products to different customers. Merchants can contact customers (e.g., via a user device 120). However, merchants typically do not have access to advertisement tools, such as advertising platforms, necessary to facilitate sophisticated advertising campaigns. Instead, merchants with access to valuable first-party data rely on third-party advertising platforms 115 to inform first-party users of their products. Third-party advertising platforms 115 typically do not sell products to customers and thus do not have access to first-party data 230. First-party data 230 includes intimate details for customers that are private to each respective customer. Therefore, the merchant may be reluctant to provide this information to third-party advertising platforms 115 due to concerns with revealing private information of its customers as it would give third parties, otherwise unaffiliated with respective customers, valuable information concerning the respective customers. Moreover, if communicated without taking proper security measures, communications with intimate details for a respective customer could be intercepted by malicious parties 280 allowing unintended recipients of a communication to gain personal insights for the respective customer.

As a result, third-party advertising platforms 115 such as platform services, advertising agencies, social media services, etc. typically gain insights for their users (e.g., third-party users) through other means. A prevalent means for third-party advertising platforms 115 to generate insights for its users is through the collection and analysis of digital signals. Digital signals describe digital interactions between a user and a platform, service, or advertisement (e.g., content provided to a user) offered by a third-party. The digital signals, for example, can be descriptive of a user clicking on an advertisement, browsing for different products, or any other digital activity associated with a user's interests. These signals can be recorded by internet cookies (e.g., software packets downloaded through a search browser). Cookies can be designed to record digital signals and store information associated with the digital signals on a personal device 250 such that the information can be accessed by advertising platforms 115 for generating insights for their users. Cookies, and digital signals, can be unreliable and provide different insights for a single user across different platforms. Thus, cookie based advertisements generated by different advertising platforms can be inconsistent and, in some cases, irrelevant for a user. Moreover, internet cookies can pose privacy risks to users as they are generally unsecure and susceptible to cyberattacks by malicious parties 280.

The market intelligence service 205 described herein empowers merchants and marketers 260 to determine insights for their customers based on first-party data 230 gathered directly from their customers and provide those insights to third-party advertising platforms 115 for marketing campaigns in a “cookie-less,” secure, privacy conscious manner. The market intelligence service 205 enables privacy conscious marketer-to-advertiser communications 250 by (1) providing secure communication techniques for referencing first-party users in a manner that prevents a third-party 280, 115 from identifying first-party users with which it is not already affiliated; and (2) providing tools to the merchant for generating customer insights based on first-party data 230, thereby enabling the merchant to provide valuable information derived from first-party data 230 without directly communicating first-party data 230 to a third-party 280, 115.

As described in further detail herein, the market intelligence service 205 can include and/or be associated with an orchestration service that provides secure communication techniques for referencing first-party users. The secure communication techniques can include referencing first party users of a respective message 250 through irreversibly hashed groups made up of a plurality of individually hashed user identifiers 285. The hashed groups can be created by individually hashing personal identifiers associated with the respective first party users that are accessible to the merchant. Each hashed group can include a dataset of indecipherable variables such that the recipient 280, 115 of the message 250 including a hashed group (whether that recipient is the intended recipient 115 or a malicious intercepting party 280) will be unable to identify first party users referenced by the hash. Upon receiving a message with a hashed group, the third-party advertisement platform(s) 115 can determine whether any of its users (e.g., third-party users) are referenced by the hashed group by individually applying the same hash function used to create the hashed group to a number of identifiers corresponding to each the third-party's users. The third-party advertising platform(s) 115 can determine that a respective user is referenced by the message 250 by matching a respective hashed user identifier with a portion of the hashed group. In this way, insights for a first party customer can be sent to a number of parties, but only used by those parties that independently received a user identifier corresponding to a user identifier hashed by the merchant. This allows a “first-party” merchant to orchestrate coordinated and personalized messaging campaigns for its customers (or potential customers) across a number of different third-party platform(s) 115 without exposing intimate details entrusted to it by its customers (or potential customers).

In this regard, the market intelligence service 205 can provide the merchant with tools for generating customer insights based on first-party data 230. The tools can be used for inventory awareness, customer awareness, and/or any other self-analysis that can empower the merchant to make decisions on how to message customers, which customers to message, etc. Example tools can include a suite of algorithms (e.g., machine-learning models, etc.) for predicting a customer's lifetime value, predicting a customer's churn rate, predicting a customer's interest in products offered by the merchant, or predicting characteristics shared by potential customers. Using tools provided by the market intelligence service 205, the merchant can segment its first party users according to a customer value or churn rate, provide relevant product recommendations to customers, provide inventory-aware recommendations to customers, identify potential customers for customer acquisition, etc. The merchant can activate (e.g., act on, etc.) these insights by providing privacy conscious messages 250 with service requests 290 to a number of different third-party platforms 115. This can enable the merchant to orchestrate a customer journey for each of its customers by instructing (e.g., through service requests 290 to affiliated third-party platforms 115) third-party platforms 115 to provide consistent, personalized, and relevant advertisements 155 based insights derived from first-party data 230.

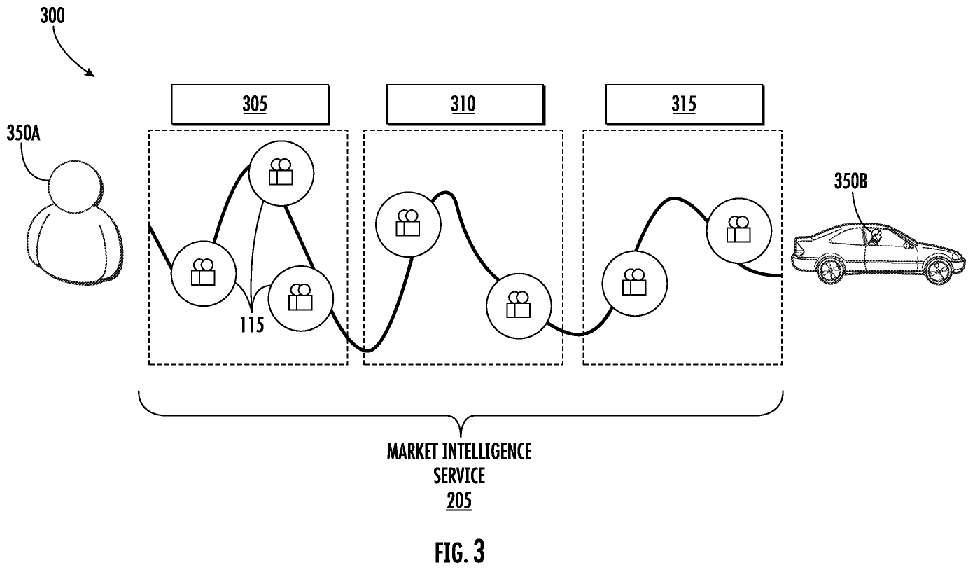

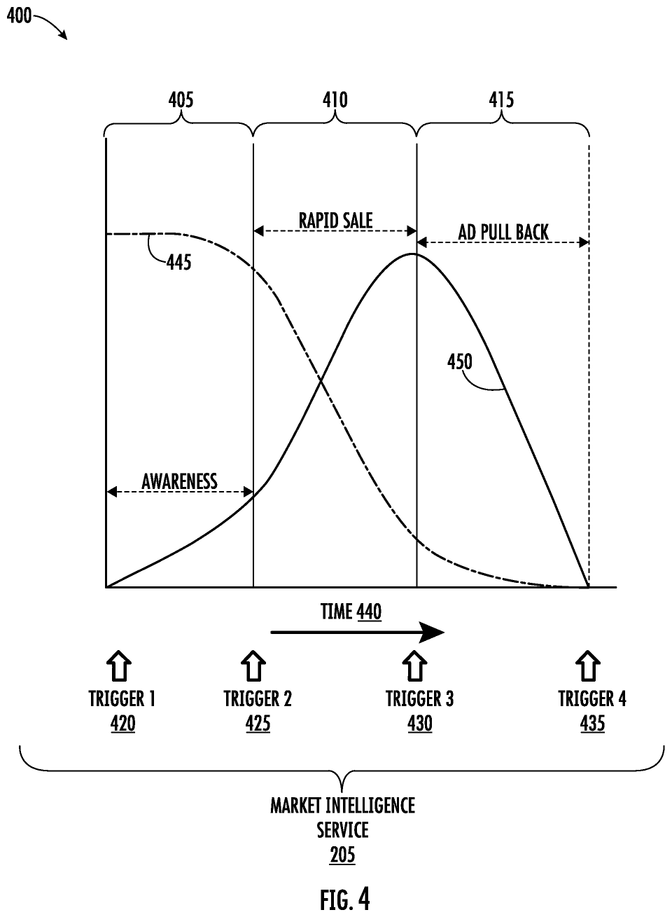

FIGS. 3 and 4 depict example marketing campaigns enabled by the present disclosure.

As one example, FIG. 3 depicts an example customer journey 300 according to example aspects of the present disclosure. A customer journey 300 can include a number of stages 305, 310, 315 for a first party user 350 during which the first party user 350 transitions from a potential first party user 350A to a buying first party user 350B. A first stage 305, for example, can include an exploratory phase for the first party user 350. During the first stage 305, the first party user 350 may not know about the merchant or one or more products offered by the merchant. A second stage 310 can include a testing phase for the first party user 350. During the second stage 310, the first party user 350 can have knowledge of the merchant and/or product(s) offered by the merchant and may be testing or sampling (e.g., through a free subscription, a trial product, a demo, etc.) the product(s). A third stage 315 can include a purchasing stage for the first party user 350 during which the potential first party user 350A becomes a buying first party user 350B.

The efficacy of a type of message and/or information provided to a first party user 350 can depend on the stage 305, 310, 315 the first party user 350 is in in the customer journey 300. For example, general messages providing information about the first-party and/or benefits/comparisons of the first-party's product(s) relative to competing products may be effective during the first stage 305 and lose efficacy as the customer progresses along the customer journey 300 (e.g., by providing redundant information, providing information about competing products, etc.). Moreover, messages providing information for testing products may be effective during the second stage 310 but lose efficacy after a first party user 350 buys the product. As another example, messages providing purchasing information may be effective after the first party user 350 reaches the third stage 315 of the customer journey 300. However, such messages may be irrelevant or too narrow while the first party user 350 is in the first stage 305 of the customer journey 300.

The market intelligence service 205 can enable the merchant to synchronize personalized messages provided to the first party user 350 at each stage 305, 310, 315 of the customer journey 300 ensuring the first party user 350 is provided consistent, personalized, and relevant messaging regardless of the message's source. For example, the market intelligence service 205 can provide tools to the merchant for the creation of a customer journey 300 specific to the merchant and/or product(s) of the merchant. Although three stages 305, 310, 315 are illustrated by FIG. 3, a customer journey 300 can include any number of stages depending on the merchant or types of products offered by the merchant. The customer journey 300 can be informed by state-based transitions of the first party user 350. The state-based transitions can be triggered based on first-party information (e.g., first-party data 230, etc.). In some implementations, the state-based transitions can be triggered based on advertisement engagements or other information obtained by a third-party advertising platform(s) 115. Each transition can advance (or demote) the first party user 350 to the next stage (or previous) of the customer journey 300. The market intelligence service 205 can enable the merchant to instruct a number of third-party advertising platform 115 to provide different messages to the first party user 350 depending on the customer's position within the customer journey. In this manner, in each stage 305, 310, 315 of the customer journey 300, the first party user 350 can receive consistent messages across a plurality of different platforms 115.

As another example, FIG. 4 depicts example inventory-aware messaging scenario 400 according to example aspects of the present disclosure. The inventory-aware messaging scenario 400 illustrates an example product lifecycle including a number of product stages 405, 410, 415. Each stage 405, 410, 415 can represent an expectation of demand and/or supply for a respective object based on, for example, historical inventory information, one or more machine-learned insights provided by inventory specific machine-learned models, etc.

As examples, the first stage 405 can include an announcement stage during which a product has been announced but is not yet available for purchase, the second stage 410 can include an initial sale phase during which products are offered for sale and supply is high, and the third stage 415 can include an extended sale phase during which products are offered for sale and supply is low. A product can advance between stages 405, 410, 415 based on one or more triggers 420, 425, 430, 435. The triggers 420, 425, 430, 435, for example, can include an announcement trigger 420 (e.g., triggered by a product announcement) that advances the product to the first stage 405, an on sale trigger 425 (e.g., triggered by a product being made available for purchase) that advances the product to the second stage 410, a low inventory trigger 430 (e.g., triggered based on inventory information for the product) that advanced the product to the third stage 415, and an out of inventory trigger 435 (e.g., triggered based on inventory information for the product) that can end the product lifecycle (or return the product lifecycle to the first stage 405 during which new inventory can be announced).

The purpose for providing messages to first party users can depend on the stage 405, 410, 415 of a product's lifecycle. For example, awareness messages including a media-mix based on driving awareness to grow audiences can be preferable in the first stage 405 of a product's lifecycle. Rapid-sale messages including personalized offers or messaging can be preferable in the second stage 410 when the product inventory is high. These messages, for example, can be guided by predictive inventory models. Advertisement pull-backs in which the messages are reduced to certain locations (e.g., with inventory) can be preferable as the product enters the third stage 415 and inventory begins to decrease. Finally, messages can automatically stop in the fourth stage when inventory runs out.

The market intelligence service 205 can enable the merchant to synchronize personalized messages provided to first party users at each product's stage 405, 410, 415 to provide consistent, inventory-aware messaging regardless of the message's source. For example, the market intelligence service 205 can provide tools to the merchant for the creation of a product lifecycle specific to the merchant and/or a respective product of the merchant. Using the market intelligence service 205, the first-party can orchestrate messaging campaigns that alter messages over time 440 to increase/decrease demand (e.g., represented by line 450) based on the inventory levels (e.g., represented by line 445) of a particular product. In this manner, the market intelligence service 205 can enable the merchant to manage advertising spending and product inventory more efficiently by orchestrating consistent inventory-aware advertising campaigns through a number of third-party advertising platforms (e.g., platform(s) 115).

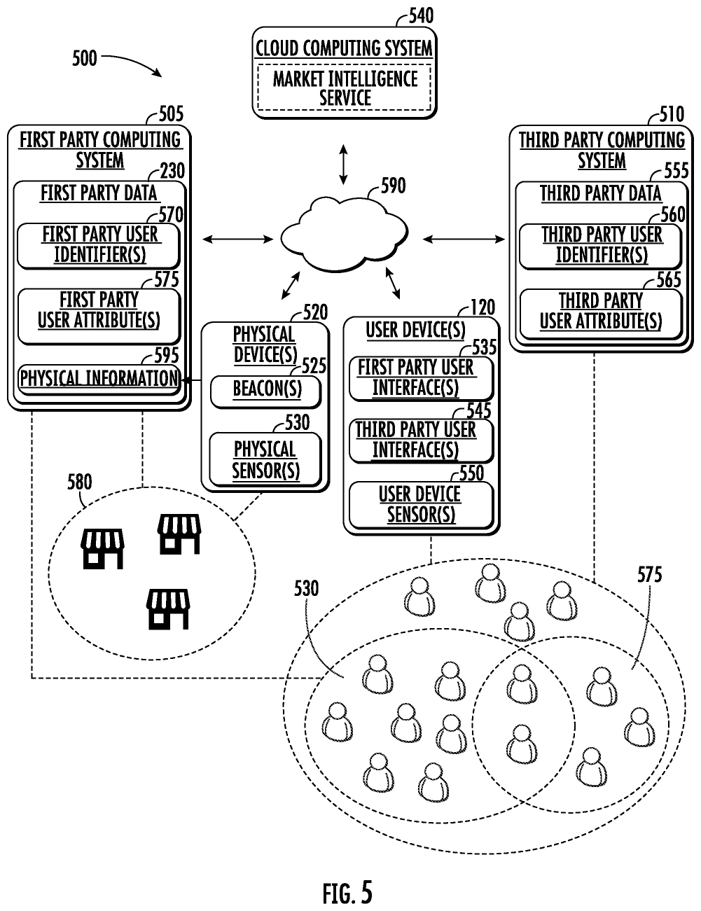

FIG. 5 depicts an example multi-party ecosystem 500 according to example aspects of the present disclosure. The multi-party ecosystem 500 can include a first-party computing system 505 and a third-party computing system 510 communicatively connected through one or more network(s) 590. The first-party computing system 505 can include one or more computing devices associated with the merchant (e.g., merchant 110) described herein. By way of example, the first party computing system 505 can include one or more computing device(s) utilized by a merchant to perform one or more merchant operations. The third-party computing system 510 can include one or more computing devices associated with the third-party advertisement platform(s) (e.g., advertisement platforms 115) as described herein. By way of example, the third party computing system 510 can include one or more computing device(s) utilized by the advertisement platforms to perform one or more advertising operations.

The first party computing system 505 and/or the third party computing system 510 can be associated with and/or communicatively connected (e.g., through network(s) 590) to one or more physical device(s) 520 and/or user device(s) 120 (e.g., such as the user device 120 described with reference to customer 140). As described herein, the multi-party ecosystem 500 can include a cloud computing system 515 that can act as an intermediary between the first party computing system 505 and the third party computing system 510. The cloud computing system 515 can include the market intelligence platform 205. In addition, or alternatively, the market intelligence service 205 can be executed on one or more first party servers of the first party computing system 505.

The one or more network(s) 590 can include any combination of various wired (e.g., twisted pair cable) and/or wireless communication mechanisms (e.g., cellular, wireless, satellite, microwave, and/or radio frequency) and/or any desired network topology (or topologies). For instance, the network(s) 590 can include a local area network (e.g., intranet), wide area network (e.g., the Internet), wireless LAN network (e.g., via Wi-Fi), cellular network, and/or any other suitable communications network (or combination thereof) for transmitting data to/from/between the first party computing system 505, the third party computing system 510, the cloud computing system 515, and/or the device(s) 520, 120.

The first party computing system 505 can be associated with a plurality of products and/or services offered by an associated merchant (e.g., a “first party”). The plurality of products can include first party items. For example, the associated first party items can include any number of items sold, manufactured, and/or otherwise affiliated with the merchant. In some implementations, the first party computing system 505 can include and/or be associated with one or more physical location(s) 580 (e.g., brick and mortar stores, etc.). Each physical location 580 can include a plurality of onsite items associated with the merchant. For instance, the onsite items can include a subset of the plurality of first party items associated with the merchant. The physical location(s) 580 can include building(s), showroom(s), supermarket(s), vending station(s), and/or any other area and/or structure in which a merchant can provide (e.g., for sale, for display, etc.) product(s) and/or service(s) to first party users 585 of the merchant.

In some implementations, the physical location(s) 515 can include one or more physical device(s) 520. The physical device(s) 520 can include computing devices located with a physical location for the purpose of gathering physical information 595 and/or facilitating transactions. For instance, the physical device(s) 520 can include point of sale systems and/or configurable display/audio configured to provide product information, physical location information, etc. In addition, or alternatively, the physical device(s) 520 can include data gathering device(s) configured to record one or more instore observations. For instance, the physical device(s) 520 can include one or more beacon(s) 525 and/or physical sensor(s) 530. The beacon(s) 525 and/or sensor(s) 530 can be configured to record observations for respective customers and/or products at the physical location(s) 580.

By way of example, a physical location 515 for the merchant can include the one or more beacon(s) 525 and/or sensor(s) 530 disposed within and/or around the physical location 515. The beacon(s) 525 and/or sensor(s) 530 can include any number and/or type of sensor such as, for example, one or more image sensors (e.g., camera, video camera, etc.), one or more audio sensors (e.g., microphone, etc.), one or more radio sensors (e.g., RADAR assemblies, Bluetooth transmitters/receptors, etc.), one or more tactile sensor(s) (e.g., capacitive touch sensors, etc.), etc. The one or more beacon(s) 525 and/or sensor(s) 530 can be configured to provide contextual data associated with at least one first party user and at least one first party item (e.g., a product) of the merchant. For instance, the one or more beacon(s) 525 and/or sensor(s) 530 can correspond to at least one first party item, one or more item type(s) associated with the at least one first party item, and/or an area of the physical location 515 associated with the first party item or item type(s).

As an example, in some implementations, each of the beacon(s) 525 and/or sensor(s) 530 can correspond to at least one first party item of a plurality of first party items associated with a respective physical location. A respective beacon 525 or sensor 530 can be disposed proximate to a corresponding item presented within the physical location 515. The corresponding item, for example, can be positioned on a podium, in a display case, and/or otherwise presented within the physical location 515. As another example, one or more of the one or more beacon(s) 525 and/or sensor(s) 530 can correspond to at least one area of the physical location 515. A respective beacon 525 and/or sensor 530 can be disposed proximate to a corresponding area associated with at least one of a plurality of different item types (e.g., sports, clothing, media entertainment, etc.) within the physical location 515. In some implementations, the one or more beacon(s) 525 and/or sensor(s) 530 can correspond to the at least one item type associated with the corresponding area and/or one or more first party items within (e.g., presented within) the corresponding area.

The one or more of first party beacons 525 can include (and/or be included as a part of) can include (and/or be included in a device that includes) one or more radio beacons configured to broadcast one or more radio frequencies. The physical sensors 530 can include one or more tactile sensors (e.g., to detect motion of an item placed relative to the tactile sensor, etc.), one or more radar sensor(s) (e.g., as described herein), and/or any other sensor described herein. The first party beacons 525 and/or the physical sensors 530 can be positioned throughout a respective physical location 515 such as, for example, in one or more podiums, display cases, and/or any other structure and/or device with which an onsite item is presented within the physical location 515. The first party beacons 525 and/or the physical sensors 530 can be configured to receive sensor data measured by the one or more sensor(s) 520, 530 and provide the physical information derived from the sensor data to the first party computing system 505.

The merchant can be associated with a plurality of first party users 585. The plurality of first party users 585 can include a number of customers and/or potential customers that have purchased, shown interest in purchasing, and/or are otherwise associated (e.g., via a first party account, subscription, etc.) with the merchant. For example, the merchant can have a register of one or more of a plurality of users 585. The register, for example, can include a list of user accounts with the merchant, a list of customers that have previously purchased a product from the merchant, a list of potential customers that have expressed interest (e.g., through a free subscription, a customer service request for product information, etc.) in a product, etc.

In some implementations, the merchant can include and/or otherwise be associated with a first party software application (e.g., configured to provide first party user interface(s) 535). The first party software application can be accessible to one or more of the plurality of first party users 585, for example, via a user device 120 associated with a respective user. The user device 120, for example, can include one or more processors and a memory storing instructions that when executed by the one or more processors cause the device to perform operations. By way of example, as described herein, the user device 120 can include a user's mobile phone, personal laptop, smart watch, and/or any other device associated with a respective customer such as customer 140.

The first party software application can be configured to present one or more first party user interface(s) 535 associated with one or more of the first party items, physical locations 515, etc. to the plurality of first party users 585 through the user device 120 (e.g., through one or more display device(s) of the user device 120). For instance, a first party user interface 535 can provide, for display, a content item (e.g., an advertisement, coupon, etc.) descriptive of a particular first party item, one or more first party items of a particular item type, and/or one or more areas within a physical location 515. A first party user can engage with the first party software application to receive information for first party items/physical locations associated with the merchant, provide information to the merchant (e.g., through a first party user account, etc.), and/or interact (e.g., purchase, favorite, dislike, review, etc.) with a particular first party item.

In some implementations, the user device 120 can include one or more user device sensor(s) 550. The user device sensor(s) 550 can include any type of sensor capable of detecting user activity and/or information associated with user activity. By way of example, the user device sensor(s) 550 can include one or more location sensor(s) (e.g., Global Positioning Systems, etc.), one or more motion sensor(s) such as, for example, accelerometer(s), inertial measurement unit(s), image sensors (e.g., camera, video camera, etc.), one or more audio sensors (e.g., microphone, etc.), and/or any other sensor capable of generating data for determining a motion, location, image, or other data relating to a respective user/user device 120. In some implementations, the user device 120 can be communicatively connected to one or more ancillary user device(s) (e.g., a smart watch, etc.) including at least one of the user device sensor(s) 550. The user device 125 can receive movement data associated with a user of the user device 120 via the user device sensor(s) 550. In some implementations, the movement data can be indicative of a physical interaction (e.g., an approaching action, a viewing action, a touching action, a holding action, etc.) with respect to a first party item and/or physical location 515 associated with the merchant.

As described in further detail herein, the first party computing system 505 can include one or more processors and a memory storing instructions that when executed by the one or more processors cause the first party computing system 505 to perform operations. Moreover, the first party computing system 505 can include and/or have access to one or more secure servers. For example, the first party computing system 505 can be associated with the cloud computing environment hosted by the cloud computing system 515. In this way the first party computing system 505 can access the market intelligence service 205 through the cloud computing system 515. In addition, or alternatively, the first party computing system 505 can include one or more servers configured to perform one or more operations of the market intelligence service 205.

The market intelligence service 205 can provide one or more marketing service(s) (e.g., software services, etc.) for use by the first party computing system 505 (through the cloud computing system 515 and/or a standalone application running at the first party computing system). By way of example, the market intelligence service 205 can offer one or more application programming interfaces (“APIs”) to the first party computing system 505. The one or more API(s) can enable the merchant to securely collect, store, and/or transfer first party data 230 (and/or one or more insights derived thereof) associated with one or more of the plurality of first party users 585.

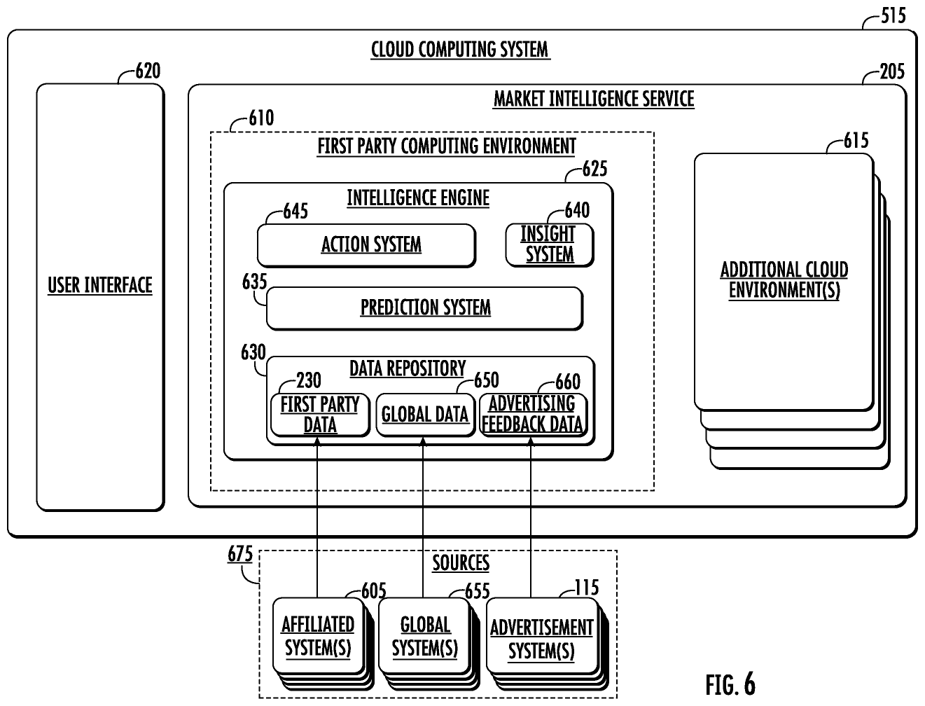

By way of example, FIG. 6 depicts an example cloud computing system 515 according to example aspects of the present disclosure. FIG. 6 illustrates one example in which the market intelligence service 205 is offered by the cloud computing system 515. As noted herein, the market intelligence service 205 can be run and/or accessed by the first party computing system 505 in a variety of manner including, for example, as a standalone application executed by the first party computing system 505 (and/or one or more servers thereof). The example depicted by FIG. 6, the cloud computing system 515 includes a trusted server that hosts a plurality of cloud environments 610, 615 for a plurality of merchants (e.g., apparel, sporting goods, etc.), retailers (e.g., department stores, etc.), marketers (e.g., marketing departments of various retailers, etc.), and/or any other entity with firsthand customer information. Each cloud environment 610, 615 can correspond to a respective first party entity. For example, the respective first party entity (e.g., the merchant associated with first party computing system 505) can create an account with the cloud computing system 515 to enable access to a first party entity specific computing environment 610 hosted by the cloud computing system 515.

The merchant associated with the first party computing system 505 can create and/or access the first party computing environment 610, whereas a plurality of other merchant entities can create and/or access a respective additional cloud environment 615. Each cloud environment 610, 615 can include separate storage space on a secure server accessible only to a respective merchant. In this manner, each first party entity associated with the cloud computing system 515 can independently import respective first party data and utilize one or more API(s) and/or other software tools provided by the cloud computing system 515.

The cloud computing system 515 can include online portal (e.g., user interface 620) that can provide a respective first party entity access to a respective cloud environment for use in collecting, analyzing, and acting on first party data information. The online portal (e.g., user interface 620) can provide access to a separate cloud environment 610, 615 for each participating first party such that information associated with customers of a participating first party can be securely stored without jeopardizing customer privacy.

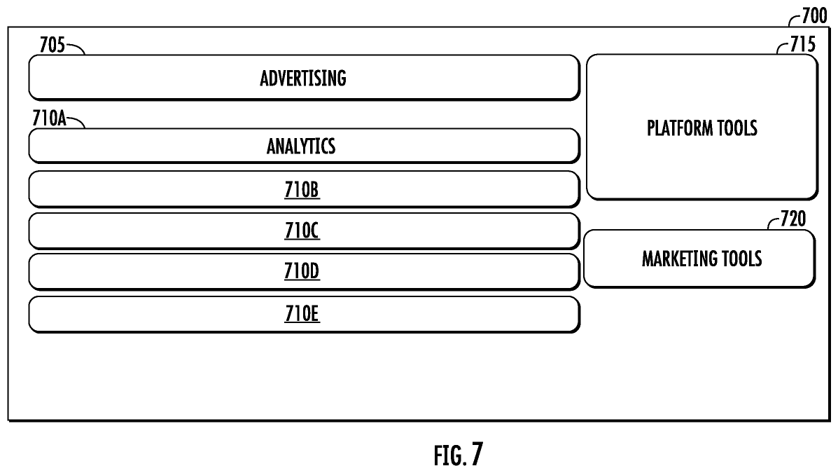

As one example, the first party computing environment 610 can include a user interface 620 (e.g., an online portal to log in, import data, set preferences, generate insights, etc.) and an intelligence engine 625. FIG. 7 depicts an example user interface 700 according to example aspects of the present disclosure. The user interface 700 can provide access to a number of advertising tools 705, analytical tools 710A-E, platform tools 715, and/or marketing tools 720 provided by the cloud computing system. The advertising tools 705 can provide access to one or more customer and/or product insights for the merchant. The analytical tools 710A-E can provide access to one or more data insights for the merchant. For instance, the tools 710A-E can include an analytics tool 710A for gaining historical insights from first party data, data studio tools 710B for gaining insights on data management, an optimization tool 710C for optimizing data mappings and/or management, a survey tool 710D for creating management surveys, and/or a tag manager tool 710E for management of tags, labels, and/or other correlations of imported first party data. The platform tools 715 can provide access to one or more data importations services for importing first party data to the cloud computing system. The marketing tools 720 can provide access to one or more customer insight engines configured to generate customer and/or product insights for the merchant based on the first party information.

Turning back to FIG. 6, the first party computing environment 610 can include an intelligence engine 625 configured to ingest and map data associated with a plurality of first party users of the merchant, gather insights based on the mapped data, and export the insights to one or more third parties (e.g., advertisement platforms, etc.). The intelligence engine 625 can enable merchants to unlock the full potential of their data. For example, the intelligence engine 625 can include a data repository 630, a prediction system 635, an insight system 640, and/or an action system 645. The data repository 630 can be configured to collect data (e.g., through interaction with source(s) 675), the prediction system 635 can be configured to analyze the data, the insight system 640 can be configured to generate one or more insight(s) based, at least in part, on the analysis, and the action system 645 can be configured to initiate an action based, at least in part, on the analysis and/or insight(s).

The informational source(s) 675 can include the plurality of first party device(s), user device(s), and/or any other device, system, or source that provides and/or maintains data relevant to customers (e.g., first party users) of the merchant. For example, with reference to FIG. 5, the first party computing system 505 can receive (and/or import to the first party cloud computing environment 610) first party data 230 associated with the plurality of first party users 585 (e.g., customers, potential customers, etc.) and/or first party products. The first party data 230 can include customer information and/or inventory information for a merchant. The customer information, for example, can include first party user account information (e.g., user preferences, activity information, etc.), transaction records (purchase history, etc.), contextual data (e.g., customer support, physical signals, etc.), and/or any other information related to a first party user 585 of the merchant. The inventory information can include product availability information, product demand information, product specifications, or any other information related to products offered by the merchant.

The customer information can include one or more first party user identifier(s) 570 and/or one or more first party user attribute(s) 575 for each of the plurality of first party users 585. The first party user identifier(s) 570, for example, can include identifiable information for one or more of the plurality of first party users 585. User identifier(s) for a respective user can include a user's name (e.g., first, last, middle, etc.), an electronic address (e.g., email, account number, etc.), a phone number, a physical address (e.g., street, zip code, city, country, etc.), and/or any other identifying information for the first party user 585. The customer information can be obtained directly from a respective first party user, for example, in the event that the respective first party user creates an account with the merchant, purchases a product from the merchant, contacts customer service regarding a promotion, and/or otherwise interacts with the merchant. By way of example, in order to fulfill a transaction, obtain a coupon, etc. the first party user may provide a name, address, and/or other identifying information directly to the merchant.

The first party user attribute(s) 575 can be descriptive of transactions between a first party user and the merchant, preferences and/or interests of the first party user, or other observations for the first party user with respect to the merchant. As an example, the first party user attribute(s) 575 can include transactional attributes indicative of purchase(s) (e.g., a recency of purchases, a frequency of purchases, a monetary value of purchases, etc.) of product(s)/service(s) offered by the merchant. The first party user attribute(s) 575 can also include contextual attribute(s) indicative of observations of a first party user that are not tied to actual transactions. The contextual attributes, for example, can include demographic information (e.g., age, gender, education-level, income-level, etc.), user preferences (e.g., set by a user account, inferred by customer interactions, etc.), user activity (e.g., customer service requests, physical interaction with products, subscriptions, etc.), and/or any other information associated with a respective first party user or potential first party user of the merchant. The contextual attribute(s) can be indicative of an expressed interest from a first party user with respect to a product offered by the merchant. For example, the contextual attributes can describe customer inquiries about a product or related products and/or other expressions of interest by the customer. In some implementations, the contextual attribute(s) can be descriptive of physical interactions (e.g., picking up an item, looking at an item, etc.) between a product and a (potential) first party user.

Turning back to FIG. 6, the first party data 230 can be collected and/or stored through a data repository 630 of the first party computing environment 610. The merchant can leverage one or more API(s) provided by the market intelligence service 205 to obtain, store, analyze, and/or act on the first party data 230 and, in some implementations, supplemental global data 650 and/or advertising feedback data 660. The data repository 630 can be configured to collect the first party data 230 and global data 650 associated with the plurality of first party users from a variety of sources 675 (e.g., affiliated system(s) 605, global system(s) 655, etc.). This enables the data repository 630 to onboard and consolidate data from a plurality of different marketing silos used by the merchant. In some implementations, the data repository 630 can also ingest information provided by affiliated third parties (e.g., the third party computing system 510, etc.). For example, the data repository 630 can receive advertising feedback data 660 provided by affiliated third party, advertisement platform(s) 115.

The source(s) 675, for example, can include a plurality of affiliated system(s) 605 (e.g., third party servers, first party system(s), etc.) configured to run software, platforms, etc. accessible to the first party computing system 505. By way of example, the first party data 230 can include data received through the one or more affiliated system(s) 605. The affiliated system(s) 605, for example, can include customer relationship management software (“CRM system”), customer data platforms (“CDP system”), enterprise resource planning software (“ERP system”) and/or any other software or service accessible to the first party computing system 505. As an example, the CRM systems can include a collection of software accessible to the merchant that is configured to record interactions with users (e.g., customers) of the merchant. The interactions, for instance, can include transactions (e.g., sales, purchases, etc.), technical support, marketing, customer service, and/or any other interaction between a customer/user and merchant. The CDP systems can include a collection of software accessible to the first party computing system 505 configured to create a persistent, unified customer database for the first party computing system 505. For instance, the customer database can include a register of a customer account/profile (e.g., user account/profile) for each of a plurality of customers and/or users affiliated with the merchant. Each account/profile can include recorded information (e.g., transaction history, observed preferences, etc.) compiled for a respective user/customer of the merchant. The ERP systems can include a collection of software accessible to the merchant that is configured to consolidate supply chain information such as physical location information (e.g., location of brick and mortar stores, supply of items at each brick and mortar store, location of warehouses, relative location and supply of items at each store and/or warehouse affiliated with the merchant, etc.), inventory information (e.g., location, availability, supply, demand, etc. of first party products), and/or other information associated with the supply of first party products to customers of the merchant.

The first party computing system 505 can make the data gathered by each of the affiliated system(s) 605 (e.g., CRM systems, CDP systems, ERP systems, etc.) available to the first party computing environment 610. For example, the cloud computing system 515 can be configured to pull data (e.g., with one or more permissions from the first party computing system 505, etc.) from each of the affiliated system(s) 605 to populate the data repository 630. In this manner, the data repository 630 can record first party data 230 from a plurality of different enterprise systems associated with the first party computing system 505.

In addition, or alternatively, the cloud computing system 515 (e.g., first party computing environment 610, etc.) can be configured to pull global data 650 from one or more global system(s) 655 (e.g., third party servers, first party device(s) configured to run globally available software, etc.) accessible to the first party computing system 505 and/or advertising feedback data 660 from one or more advertisement platform(s) 115.

The global data 650 can include publicly accessible datasets related to first party users of the first party computing system 505. By way of example, the global data 650 can be pulled from publicly accessible global system(s) 655 configured to maintain global information. The publicly accessible global system(s) 655, for example, can include weather forecasting system(s) (e.g., national oceanic atmospheric administration, etc.), consumer index system(s) (e.g., consumer confidence index, etc.), and/or any other publicly accessible system or dataset. In this manner, the cloud computing system 515 can populate the data repository 630 with global data 650 indicative of future weather forecasts, measures of consumer confidence, etc.

The advertising feedback data 660 can include data provided by one or more advertisement platform(s) 115 associated with the merchant. By way of example, the advertising feedback data 660 can include at least a portion of the third party data 555 of FIG. 5. In addition, or alternatively, the advertising feedback data 660 can include data gathered and made available to the first party computing system 505 by an affiliated advertisement platform 115. By way of example, the advertising feedback data 660 can include advertisement data collected by one or more advertisement platform(s) 115 such as, for example, marketing analytics, customer acquisitions, advertisement realization events, and/or any other marketing information provided by a collaborative advertisement platform 115.

In some implementations, the data repository 630 can include one or more insights and/or analytics generated by the intelligence engine 625. For example, the intelligence engine 625 can leverage the prediction system 635 to perform analytics on the collected data (e.g., first party data 230, global data 650, advertising feedback data 660, etc.). The prediction system 635 can include a layer of artificial intelligence including a plurality of machine-learning models and/or other predictive algorithms optimized to the merchant.

The machine-learning model(s) can include any type of machine-learning model configured to learn one or more insights from the first party data 230 (e.g., demographic attributes, physical signal information, location attributes, transactional attributes, etc.), global data 650, and/or advertising feedback data 660. As examples, the model(s) can be or can otherwise include various machine-learned models such as neural networks (e.g., deep neural networks), support vector machines, decision trees, ensemble models, k-nearest neighbors models, Bayesian networks, generative adversarial networks, and/or other types of models including linear models or non-linear models. Example neural networks can include feed-forward neural networks, recurrent neural networks (e.g., long short-term memory recurrent neural networks), convolutional neural networks, or other forms of neural networks.

In some implementations, the machine-learning model(s) can include one or more deep neural networks offered by the cloud computing system 515. Access to the deep neural networks, for example, can be provided through one or more interfaces (e.g., API(s), etc.) associated with the cloud computing system 515. The model(s) can include value-based model(s) configured to output value segmentations (e.g., high, medium, low value segmentations, etc.) based on first party data 230, global data 650, and/or advertising feedback data 660. As other examples, the model(s) can include predictive churn model(s) configured to output churn segmentations (e.g., high, medium, low churn rate, etc.), predictive item specific model(s) configured to output item interest segmentations (e.g., high, medium, low interest with respect to respective item(s), etc.) based on first party data, and/or any other model or combinations thereof.

In some implementations, the value-based model(s) can include a predicted lifetime value model configured to output a predictive lifetime value (e.g., high, medium, low) for one or more first party users. The predicted lifetime value model, for example, can include a deep neural network configured to take a plurality of user attributes for a first party user as input and, based on the input, learn to predict a lifetime value for the first party user. The user attributes, for example, can include transactional information and/or contextual data. The transaction information can include information indicative of a recency of the first party user's latest transaction, a frequency of the user's transactions, and/or monetary value (e.g., total, average, etc.) of transaction made by the first party user from the merchant. The contextual attributes can include information indicative of user demographics, location information, and/or information associated with one or more product interactions. In some implementations, the predicted lifetime value model can take in additional data and learn to weigh the additional data based, at least in part, on future transactions between the merchant and first party users. In this manner, the predictive lifetime value model can learn to generate accurate predictions of customer value based, at least in part, on the first party data 230, the global data 650, and/or the advertising feedback data 660 over time.

In addition, or alternatively, the predictive churn model(s) can include deep neural networks configured to output churn segmentations (e.g., high, medium, low churn rate, etc.) for one or more first party users. The predictive churn model(s), for example, can be configured to take a plurality of user attributes for a first party user as input and, based on the input, learn to predict a likelihood that the first party user will stop buying products from the merchant. The predictive churn model(s) can take in the first party data 230, the global data 650, and/or the advertising feedback data 660 learn to weigh different attributes of the data based, at least in part, on future transactions between the merchant and first party users. In this manner, the predictive churn model(s) can learn to generate accurate predictions of customer churn likelihood based, at least in part, on the first party data 230, the global data 650, and/or the advertising feedback data 660 over time.

The predictive item specific model(s) can include product recommendation model(s) configured to output product recommendations (e.g., for up-selling, cross-selling, etc. first party items) for one or more first party users. The product recommendation model(s), for example, can include a deep neural network (and/or any other type of recommendation engine) configured to take a plurality of user attributes (e.g., digital signals indicative of internet activity, physical signals indicative of physical interactions with an item, transaction history, etc.) for a first party user as input and, based on the input, learn to predict interest levels in respective products. In some implementations, the product recommendation model(s) can be configured to output recommended item list(s) (e.g., identifying the top five first party items for each first party user) for one or more of a plurality of first party users.

The merchant can input the first party data 230, the global data 650, and/or the advertising feedback data 660 to the prediction system 635 (and/or one or more model(s) thereof) to receive the one or more insights (and/or group segmentations) associated with the plurality of first party users. The merchant can generate the one or more groups based, at least in part, on such insights. In this manner, the merchant can utilize one or more pre-packaged machine-learning models (e.g., of the prediction system 635) to generate one or more user subsets (e.g., user groups) based, at least in part, on actionable predictive analytics.

For instance, the prediction system 635 can generate the one or more user groups (e.g., segmentations of first party users, etc.) based, at least in part, on the first party data 230, the global data 650, the advertising feedback data 660 and/or one or more insights derived from the predictive model(s). Each of the one or more user groups can include a subset of the plurality of first party users associated with one or more common attributes. The common attribute(s), for example, can include attribute(s) that provide one or more insights for a respective subset of users. For instance, the common attribute(s) can include common demographic attributes, purchase histories, user preferences, etc. with which one or more insights (e.g., a product interest, a value to the merchant, etc.) have been (and/or can be) derived.

For example, the user groups can be generated by leveraging one or more insights of the predictive machine-learning models provided by the market intelligence service 205 (e.g., the prediction system 635). As an example, the user groups can include high-value groups including first party users associated with a high predictive lifetime value (e.g., a lifetime value that achieves a high value threshold, etc.); medium-value groups including first party users associated with a medium predictive lifetime value (e.g., a lifetime value that achieves a medium value threshold, etc.); and/or low-value groups including first party users associated with a low predictive lifetime value (e.g., a lifetime value that achieves a low value threshold, etc.). In addition, or alternatively, the user groups can include high-churn groups including first party users associated with a high predictive churn rate; medium-churn groups including first party users associated with a medium predictive churn rate; and/or low-churn groups including first party users associated with a low predictive churn rate. Moreover, in some implementations, the user groups can include a plurality of similar interest groups. Each of the plurality of similar interest groups can include a subset of first party users with interests in similar items (e.g., a similar top five item list, etc.).

In some implementations, the prediction system 635 can determine group segmentation based, at least in part, on a combination of user insights. By way of example, the prediction system 635 can determine high-value-low-churn rate groups including first party users associated with a high predicted life-time value and a low churn rate; high-value-similar-interest groups including first party users associated with a high predicted life-time value and similar item interests; high-value-high-churn rate groups including first party users associated with a high predicted life-time value and a high churn rate; and/or any other group including any other combination of insights.

The one or more insights can be provided to the insight system 640 and/or the action system 645. The insight system 640 can be configured to store, analyze, and/or report the one or more insights. By way of example, the insight system 640 can generate one or more first party user profiles indicative of one or more insights (e.g., and/or user groups) determined for one or more first party users. The user profile(s), for example, can be indicative of the one or more insights and/or one or more user attribute(s) related to each of the one or more insights. In addition, or alternatively, the insight system 640 can generate one or more user report(s) including a holistic review of a plurality of insights generated for the plurality of first party users over time. The user report(s), for example, can include information indicative of a number, growth over time, etc. of high-value users, expected churn rates, historical churn rates, etc. for the high-value users, etc. The insight system 640 can provide the one or more user profile(s) and/or report(s) for display to a first party user through the user interface 620. In addition, or alternatively, the insight system 640 can provide the one or more user profile(s) and/or report(s) to the data repository 630 for use in generation one or more additional insights.

The action system 645 can be configured to initiate an action based, at least in part, on the one or more insights and/or user groups derived thereof. By way of example, the action system 645 can activate one or more user insights by providing personalized messages (e.g., content items such as advertisements, etc.) to one or more of the first party users and/or by providing instructions to one or more third party system(s) (e.g., advertisement platforms, etc.) to provide specific messages (e.g., content items) to the one or more first party user(s). In some implementations, the action system 645 can create a customer journey (e.g., customer journey 300, etc.) for each of the first party users by correlating activations of insights based on one or more different stages of a first party user's involvement with the merchant. In this manner, the action system 645 can enable a merchant to provide consistent, personalized, and relevant messaging to first party users across a plurality of different user device(s) and/or platform(s) (e.g., third party computing system(s), etc.).

For example, turning back to FIG. 5, the third party can be associated with a third party computing system 510. The third party computing system 510, for example, can be associated with an advertisement platform (e.g., the advertisement platform(s) 115 described herein). The advertisement platform can be in collaboration with the merchant, for example, to advertise one or more items or services offered by the merchant. By way of example, the advertisement platform can include an entity configured to provide one or more advertisements and/or other messaging services (e.g., user acquisition, personalized product advertisements, etc.) for the merchant.

The advertisement platform can include and/or be associated with a plurality of third party users 590. The plurality of third party users 590 can have an account with and/or otherwise utilize one or more services, platforms, etc. of the advertisement platform. For example, the advertisement platform can include and/or be associated with an internet browser, a video player application, a social media platform, an advertising agency, and/or any other interactive interface (e.g., third party user interface(s) 545) and/or third party software applications for engaging with the plurality of third party users 590.

By way of example, the advertisement platform can include and/or otherwise be associated with a third party software application (e.g., configured to provide third party user interface(s) 545). The third party software application can be accessible to one or more of the plurality of third party users 590, for example, via user device 120 associated with the third party users 590. The user device 120, for example, can be and/or include one or more of the user device 120 associated with the first party users 585.

The third party software application can be configured to present one or more third party user interface(s) 545 associated with one or more of the first party items, physical locations 515, etc. to the plurality of third party users 590 through the user device 120 (e.g., through one or more display device(s) of the user device 120). For instance, a third party user interface 545 can provide, for display, a content item descriptive of a particular first party item, one or more first party items of a particular item type, and/or one or more areas within a physical location 515. A third party user can engage with the third party software application to receive information for first party items/physical locations associated with the merchant, provide information to the third party (e.g., through a third party user account, etc.), and/or interact (e.g., purchase, favorite, dislike, review, etc.) with a particular first party item.

The advertisement platform can include and/or have access to third party data 555. The third party data 555 can include information associated with the plurality of third party users 590. In some implementations, the third party data 555 can include one or more third party user identifier(s) 560 and/or third party user attribute(s) 565 for one or more of the plurality of third party users 590. The third party user identifier(s) 560 and/or third party user attribute(s) 565 can include any identifier(s) and/or attributes discussed above with reference to the first party user identifier(s) 570 and/or the first party user attribute(s) 575.

In some implementations, the third party data 555 can be indicative of a plurality of third party user accounts associated with an advertisement platform. For instance, the third party data 555 can include one or more user preferences, user identifiers, activity information, etc. for each of the plurality of third party users 590. By way of example, each of the plurality of third party user accounts can include one or more third party user identifier(s) 560 (e.g., a name, email, phone number, physical address, etc.), third party user attribute(s) 565 (e.g., transaction history, user preference(s), etc.), and/or any other information associated with a corresponding third party user.

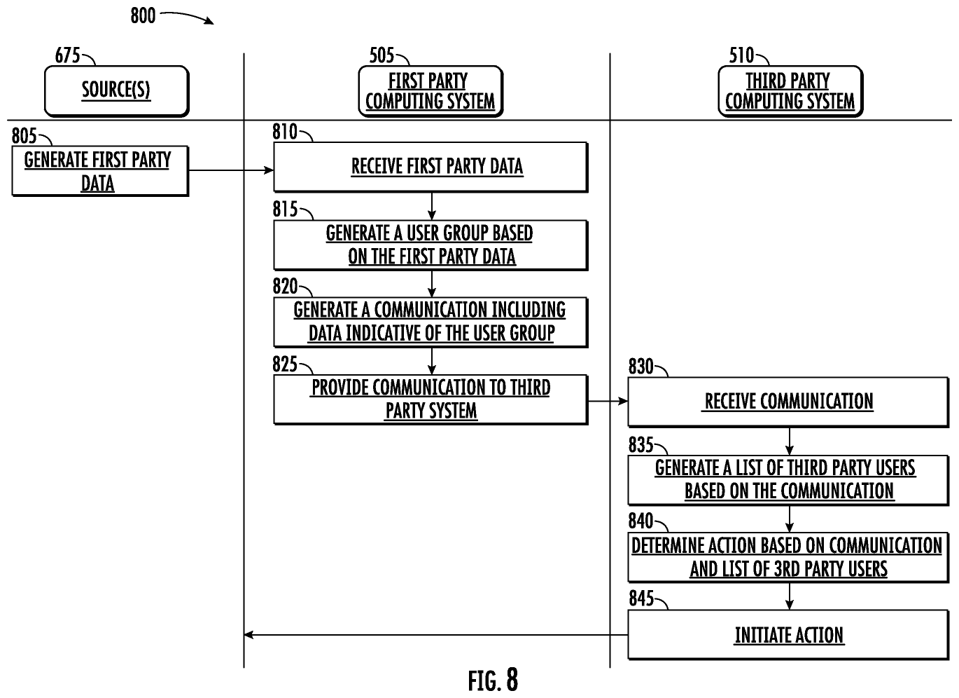

FIG. 8 depicts an example activity diagram 800 for privacy conscious market collaboration according to example aspects of the present disclosure. The activity diagram 800 depicts interactions between a variety of informational source(s) 675, the first party computing system 505 associated with a merchant, and the third party computing system 510 associated with an advertisement platform.

At (805), the source(s) 675 can generate first party data. The first party data, for example, can include any information associated with a first party user (e.g., a customer and/or potential customer of the associated merchant), products/services offered by an associated merchant as described herein. The first party computing system 505 can receive the first party data at (810).

At (815), the first party computing system 505 can generate a user group based, at least in part, on the first party data. For example, the first party computing system 505 can generate one or more user groups (e.g., marketing audience(s), etc.) based, at least in part, on the first party data using one or more tools provided by a market intelligence engine. Each of the one or more user groups can include a subset of the plurality of first party users associated with one or more common attributes. The common attribute(s), for example, can include attribute(s) that provide one or more insights for a respective subset of users. For instance, the common attribute(s) can include common demographic attributes, purchase histories, user preferences, etc. with which one or more insights (e.g., a product interest, a value to the merchant, etc.) have been (and/or can be) derived. As an example, a common attribute can be a particular product that each user is interested in.

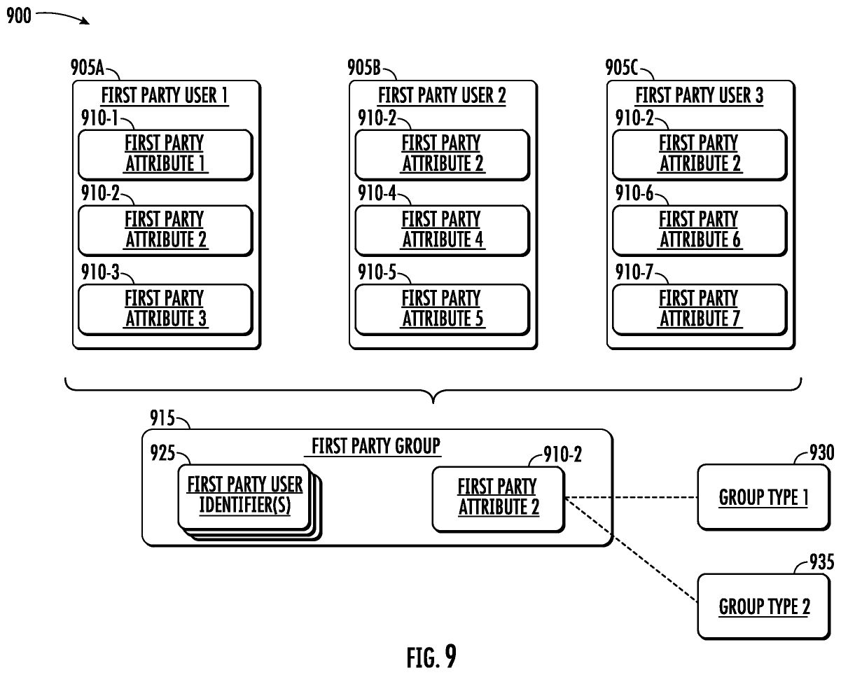

By way of example, FIG. 9 depicts an example user group scenario 900 according to example aspects of the present disclosure. The user group scenario 900 depicts a subset of first party users 905A-905C associated with a plurality of respective attributes 910-1-910-7. For example, first party user 905A can be associated with first party attributes 910-1-910-3, first party user 905B can be associated with first party attributes 910-2, 910-4, 910-5, and first party user 905C can be associated with first party attributes 910-2, 910-6, 910-7. The first party attribute(s) 910-1-910-7 can include any one of the user attributes described herein such as, for example, a previous transaction, a zip code, a user preference, etc. associated with a respective user 905.

As depicted, the subset of user(s) 905A-C can include at least one common attribute 910-2. The common attribute(s) 910-2 for the subset 905A-C of a plurality of first party users can be representative of one or more insights for the users 905A-C such as, for example, a predicted lifetime value, a respective churn rate, similar item interests, etc. For example, as described herein, the common attribute(s) 910-2 can include attribute(s) that provide one or more insights for a respective subset of users. The common attribute(s) 910-2 can include common demographic attributes, purchase histories, user preferences, etc. with which one or more insights (e.g., a product interest, a value to the merchant, etc.) have been (and/or can be) derived.

As one example, the common attribute(s) 910-2 can be indicative of a common interest level for a respective item. The common attribute(s) 910-2, for example, can include one or more transactional attributes indicative of a transaction associated with a respective item (e.g., a past transaction including the item, a related item, etc.) and at least one respective user of the subset 905A-C of the plurality of first party users. In addition, or alternatively, the common attribute(s) 910-2 can include contextual attribute(s) indicative of an association between the respective item and at least one respective user of the subset 905A-C of the plurality of first party users. The contextual attribute(s), for example, can be descriptive of one or more physical interaction(s) (e.g., picking up an item, analyzing an item, etc. in a brick and mortar store) between the respective item (and/or related item) and the at least one respective user of the subset 905A-C of the plurality of first party users. As other examples, the contextual attribute(s) can include user preference(s), demographic information, and/or any other information associating a respective user with a respective item.

The merchant can generate a first party user group 915 based, at least in part, on the subset of first party users 905A-C and the at least one common attribute 910-2. The first party user group 915 can include one or more first party user identifier(s) 925 for each first party user 905 of the subset of first party users 905A-C. The first party user identifier(s) 925, for example, can include any of the first party user identifier(s) described herein (e.g., first/last name, address, username, etc.). In addition, or alternatively, the user group 915 can include data indicative of the at least one common attribute 910-2 and/or any other attributes associated with at least one of the first party user(s) 905A-C.

In some implementations, the user group 915 (and/or each of the plurality of the generated user groups) can be associated with at least one group type 930 of a plurality of different group types. Each group type can be descriptive of the one or more common attributes of a respective subset of users and/or one or more insights thereof. As examples, the plurality of group types can include one or more value-based group types, one or more item-based group types, and/or one or more churn-based group types. The value-based group types can be descriptive of a predictive life-time value of a subset of users to the merchant. By way of example, the value-based group type(s) can include a high value type (e.g., indicative of customers that are predicted to spend a high threshold currency over a period of time), a medium value type (e.g., indicative of customers that are predicted to spend a medium threshold currency lower than the high threshold currency over a period of time), and/or a low value type (e.g., indicative of customers that are predicted to spend a low threshold currency lower than the medium threshold currency over a period of time). The item specific group type(s) can be descriptive of a subset of users with a predicted interest in a respective item offered by the merchant. The churn-based group types can be descriptive of a predicted time period during which a subset of users are predicted to engage with the merchant. For example, the churn-based group types can include a high churn group type including a subset of users that are predicted to stop engagement (e.g., cancel a subscription, stop purchasing items from the merchant, etc.) with the merchant within a period of time (e.g., one or more days, weeks, months, years, etc.).

In some implementations, the user group 915 can be associated with a combination of group types. For example, the user group 915 can include a high value type 930 and a high churn type 935. The group 915, for example, can include a subset of first party users 905A-905C including high value users that are predicted to stop engaging with the merchant within a relatively short time period (e.g., relative to an average user, within a predetermined threshold (e.g., a week, month, year, etc.), etc.). Other group(s) can include high-value customers with a high interest in a particular product offered by the merchant.

Turning back to FIG. 8, at (820) of the activity diagram 800, the first party computing system 505 can generate a communication including data indicative of the user group. For example, the first party computing system 505 can generate a privacy conscious communication for the third party computing system 510 using one or more privacy conscious messaging techniques enabled by an orchestration service. To do so, the first party computing system 505 can generate the communication for the third party computing system 510 based, at least in part, on a hashed user group including one or more hashed user identifier(s) of the user group.

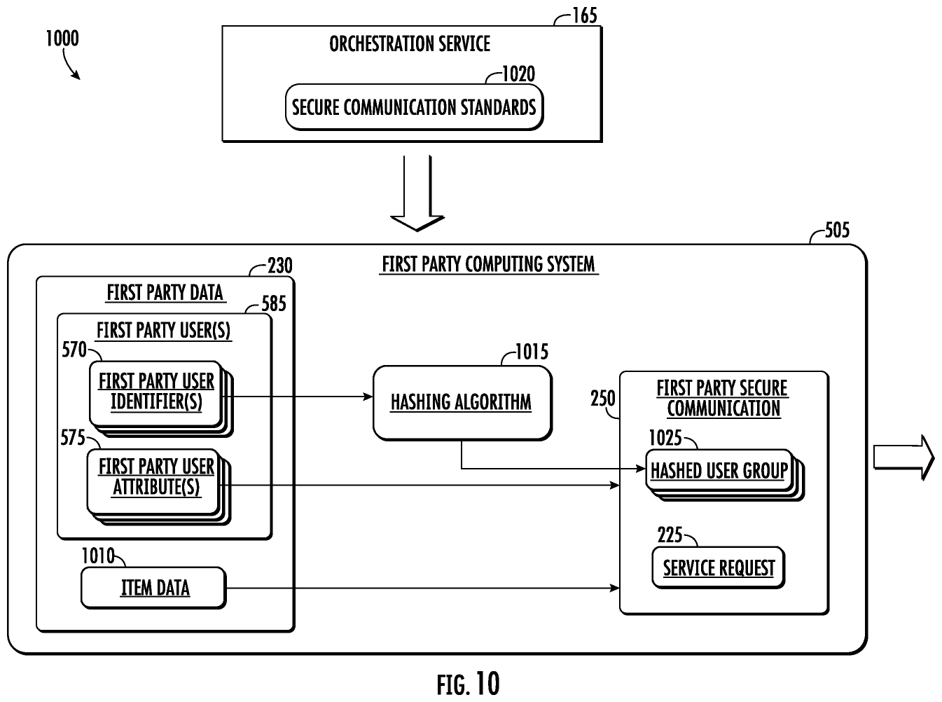

For example, FIG. 10 depicts an example block diagram 1000 for generating a privacy conscious communication according to example aspects of the present disclosure. As depicted, the first party computing system 505 can generate the first party secure communication 250 based, at least in part, on the first party user identifier(s) 570 (e.g., user identifier(s) 925 associated with user group 915 of FIG. 9) associated with a subset of the first party user 585 (e.g., subset of user(s) 905A-C of FIG. 9) and, in some implementations, item data 1010 of the first party data 230. The first party communication 250 can include a hashed user group 1025 made up of a plurality of individually hashed first party user identifier(s) 570 and a service request 290. The service request 290 can include an indication of the hashed user group 1025 and/or a request to perform one or more service operations for the merchant. The service operations can include, for example, providing personalized (advertisements e.g., based on a respective stage of a customer journey 300, etc.) for the merchant to third-party users, providing inventory aware advertisements (e.g., based on a respective stage of a product life cycle, etc.) for the merchant to third party users, and/or any other operation to facilitate consistent messaging across various third-party platforms.

The first party communication 250 can include first party data 230 such as first party user attributes 575, item data 1010, and/or insights for a number of first party user(s) 585. The first party data 230 included with the communication 250 can be encrypted or unencrypted. However, the identity of the first party user(s) 585 will always be hidden (e.g., through one or more hashes). Thus, in the event that the first party data 230 of a communication 250 is received by a party unaffiliated with a respective first party user referenced by the communication 250, the unaffiliated party will be unable to trace the information back to the hidden first party user.

The service request 290 can include a request to add first party users referenced by the hashed user group 1025 to a third party group maintained by a third party. The third party group, for example, can include a product specific group referencing third party users with an interest in specific products. The first party computing system 505 can facilitate the creation and maintenance of such a group by identifying first party users 585 with an interest in a specific product based on first party data 230, generating a hashed user group 1025 referencing the identified users, and providing the hashed user group 1025 to a third party with a service request 290 instructing the third party to add the referenced users to the product specific group. In this manner, a merchant can provide first party communication(s) 250 to a plurality of different third-party advertising platforms to facilitate consistent third-party lists across each platform. The product specific group is provided as one example. As described herein with reference to the merchant, the user group (first party or third party) can include any type or combination of types of groups such as, for example, a high-value group, a high-churn rate group, etc.

The first party computing system 505 can generate the hashed user group 1025 based, at least in part, on at least one user group (e.g., user group 915 of FIG. 9) of the one or more user groups and secure communication standards 1020 received from an orchestration service 165 as described herein. For example, the secure communication standards 1020 can identify a particular hashing algorithm 1015 to apply to the first party user identifier(s) 570 to individually hash each of the first party user identifier(s) corresponding to a first party user of a first party group. The hashed user group 1025 can include a list of individually hashed identifiers for each of the subset of users within at least one of the user group(s). For instance, the hashed list can include one or more hashed first party user identifiers 570 for each respective first party user within the user group. By way of example, the hashed identifiers for each respective first party user can include at least one of a hashed email, a hashed phone number, and/or a hashed first name, last name, and/or zip code (e.g., as illustrated by FIG. 1B).

The first party computing system 505 can receive a subset of first party user identifiers 555 for the subset of the first party users 585 within a user group such as, for example user group 915 of FIG. 9. The subset of first party user identifiers 555 can include at least one of the first party user's name, electronic/physical address, contact information, and/or any other identifying information for the first party user. In some implementations, the subset of user identifiers 555 can include at least one user identifier for each respective user in the user group.

The first party computing system 505 can generate the hashed user group 1025 based on the subset of user identifiers 555 and the hashing algorithm 1015 identified by the secure communication standards 1020. For instance, the first party computing system 505 can individually apply the hashing algorithm 1015 to the subset of user identifiers 555 to generate the hashed user group 1025. The hashing algorithm 1015 can include any type of hashing function such as, for example, at least one of a message digest algorithm (e.g., MD5), secure hash algorithm (e.g., SHA-0, SHA-1, SHA-2, etc.), local area network manager algorithm (e.g., LANMAN, NTLM, etc.), etc. In some implementations, for example, the hashing algorithm 1015 can include SHA-256. The first party communication 250 can include data indicative of and/or otherwise identify the hashed user group 1025.

The first party communication 250 can include one or more service request(s) 225 for the third party computing system 510. For example, the first party communication 250 can include a service request 290 to perform one or more service operations for the first party computing system 505. For example, as described herein, the service operations can include instructions for facilitating consistent, personalized, and/or inventory aware messaging to third-party users of the third party computing system. As examples, the service operations can include user acquisition operation(s) for acquiring new customers for the merchant, user servicing operation(s) for providing user specific information to one or more customers of the merchant (e.g., third-party users that are already first party customers), item offering operation(s) for providing item specific information to one or more users of the advertisement platform, merchant informational operation(s) for providing first party information (e.g., for a respective item, etc.) to one or more users of the advertisement platform, and/or any other servicing operations for messaging user through a respective third-party platform.

The service request 290, for example, can provide instructions for providing particular information to a third party user (e.g., based on a customer journey, product stage, etc.). The same (or different) service request 290 can be provided to a plurality of different third parties to initiate consistent marketing campaigns across multiple advertising platforms. By way of example, the service request 290 can include a request to perform user acquisition operation(s) for acquiring new customers based on a hashed user group 1025 that references potential customer identified by the merchant as in an exploratory phase (e.g., a first stage 305 of FIG. 3, etc.) for particular products or services. As another example, the service request 290 can include a request to perform item offering operation(s) for providing item specific information for a product offered by the merchant based on the product's stage (e.g., stages 405, 410, 415 of FIG. 4, etc.) in a product lifecycle.

In some implementations, the first party communication 250 can be generated based, at least in part, on the at least one group type associated with a user group. For example, the at least one group type can include a high value type (e.g., indicative of one or more high value users of the merchant). In such a case, the first party communication 250 can include a service request 290 including a request to identify potentially high value users for the merchant based, at least in part, on the hashed user group 1025. The service request 290, for example, can include a request to identify potential high value users (e.g., user acquisition operations) based, at least in part, on the subset of users within the user group (and/or one or more common attributes thereof).

In addition, or alternatively, the at least one group type can include a high churn type. In such a case, the first party communication 250 can include a service request 290 including a request to provide an incentive to one or more users associated with the recipient of the first party communication 250 based, at least in part, on the hashed user group. By way of example, the recipient can include the third party computing system 510. In such a case, the first party communication 250 can include a service request 290 including a request to provide an incentive (e.g., user servicing operations) to one or more third party users associated with the advertisement platform based, at least in part, on the hashed user group 1025. In some implementations, the at least one group type can include a respective item type and the first party communication 250 can include a service request 290 including a request to provide item specific information (e.g., item data 1010) to one or more third party users associated with the advertisement platform based, at least in part, on the hashed user group 1025.

Turning back to FIG. 8, at (825) of the activity diagram 800, the first party computing system 505 can provide the first party communication 250 to the third party computing system 510. For example, the first party computing system 505 can communicate the first party communication to the third party computing system 510. The third party computing system 510 can receive the communication at (830). For example, the third party computing system 510 can receive the first party communication 250 from the first party computing system 505. The first party communication 250 can include the hashed user group 1025 and/or the service request 290 including a request to perform one or more service operations.

At (835), the third party computing system 510 can generate a list of third party users based on the communication. For example, the third party computing system 510 can reference at least one of the subset of first party users within at least one user group based, at least in part, on the hashed user group, the hashing algorithm (e.g., as prescribed by the orchestration service), and/or third party user data associated with the third party computing system 510.

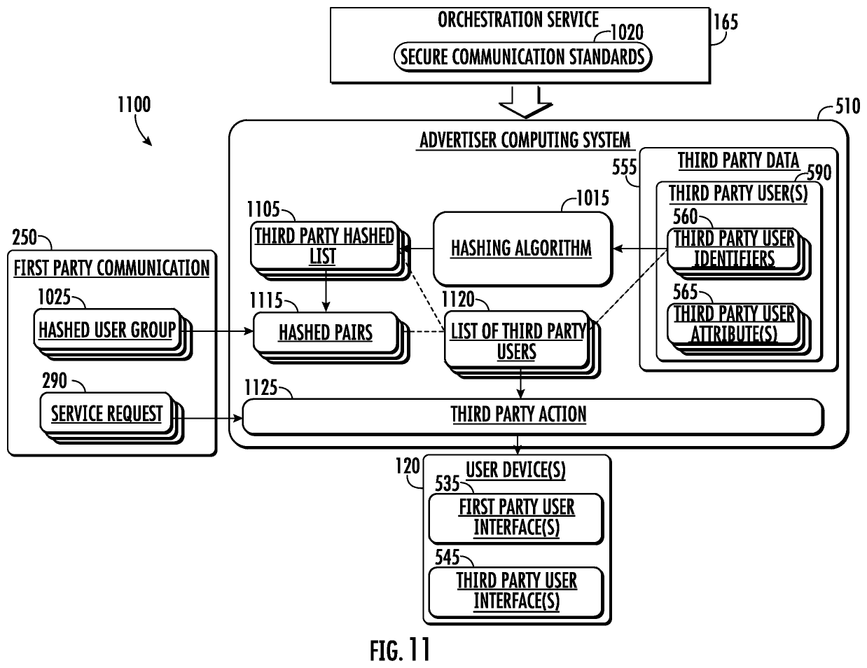

By way of example, FIG. 11 depicts an example block diagram 1100 for referencing third party users based on a privacy conscious communication according to example aspects of the present disclosure. As depicted, the third party computing system 510 can receive a first party communication 250 including data indicative of a hashed user group 1025 and/or a service request 290. The third party computing system 510 can generate a third party hashed list 1105 based, at least in part, on a plurality of third party user identifier(s) 560 corresponding to a plurality of third party users 590 identified by the third party data 555 and the secure communication standards 1020 received from the orchestration service 165 as described herein. For example, the secure communication standards 1020 can identify a particular hashing algorithm 1015 to apply to the third party user identifier(s) 560. Each third party hashed identifier of the third party hashed list 1105 can correspond to a respective third party user identifier of the third party user identifier(s) 560. The third party computing system 510 can generate a set of hashed pairs 1115 based, at least in part, on the third party hashed list 1105 and the hashed user group 1025 and determine a list of third party users 1120 corresponding to the first party communication 250 based, at least in part, on the set of hashed pairs 1115.

In this manner, the third party computing system 510 can compare the hashed user group 1025 to third party data 555 to reference one or more third party users 1120 associated with the first party communication 250 without any prior knowledge of the first party computing system 505, a subset of first party users associated with a merchant generated user group, or the plurality of first party users of a merchant. For example, in the event that the same user is affiliated with both the merchant (e.g., is a customer, etc. of the merchant) and the advertisement platform (e.g., is a user of an advertisement platform), the third party data 555 can include third party user identifier(s) 560 corresponding to a respective first party user identifier 555 for the affiliated user. This enables the third party computing system 510 to reference an affiliated user of the hashed user group 1025 by hashing the same information hashed by the merchant (e.g., corresponding user identifiers) and matching the hashed information to at least a portion (e.g., an individual digest included in the hashed user group 1025) of the hashed user group 1025. In this manner, the first party computing system 505 can securely transmit hashed information associated with one or more first party users over one or more networks (e.g., secure, or unsecure) without exposing information associated with its users such as transaction history, value to the first party, etc. to malicious parties.

More particularly, the third party computing system 510 can generate a third party hashed list 1105 based, at least in part, on the third party data 555 and the hashing algorithm 1015 identified by the secure communication standards 1020. The hashing algorithm 1015 can include any type of hashing function such as, for example, any of the hashing algorithms described herein. The hashing algorithm 1015 is the same hashing algorithm utilized by the first party computing system 505. The third party computing system 510 can individually apply the hashing algorithm 1015 to at least one of the one or more third party user identifier(s) 560 for each of the plurality of third party users 590 (e.g., user accounts, etc.) to generate the third party hashed list 1105.

The third party hashed list 1105 can include a plurality of hashed third party identifiers corresponding to the plurality of third party user identifier(s) 560. For example, each hashed third party identifier can correspond to a respective third party user identifier. Each hashed third party identifier can reference a respective third party user based, at least in part, on the corresponding third party user identifier. The plurality of third party user identifier(s) 560 corresponding to the third party hashed list 1105 can at least in part overlap the plurality of first party user identifiers 555 corresponding to the hashed user group 1025. By way of example, a user affiliated with both the merchant and the advertisement platform can provide at least one of the same user identifiers to each party. This, in turn, enables the third party computing system 510 to hash at least part of the same information used by the first party computing system 505 as the basis for the hashed user group 1025. The third party computing system 510 can generate the third party hashed list 1105 that at least partially matches the hashed user group 1025 by applying the same hash function 1015 as the first party computing system 505 to the at least partially overlapping information (e.g., an individual user identifier) used as the basis for the hashed user group 1025. By doing so, the third party computing system 510 can reference one or more third party users 1120 despite the irreversible nature of hashed information.

By way of example, the third party computing system 510 can generate a list of third party users 1120 based, at least in part, on the hashed user group 1025, the third party hashed list 1105, and the third party data 555 (e.g., the corresponding third party user identifier(s) 560, etc.). For example, the third party computing system 510 can determine one or more hashed pairs 1115 between the third party hashed list 1105 and the hashed user group 1025 of the first party communication 250. The third party computing system 510 can reference at least one of the plurality of third party users (and/or user accounts) based, at least in part, on a correlation between the hashed pair(s) 1115 and the third party user identifier(s) 560 for each of the plurality of third party users (and/or user accounts). For example, the third party computing system 510 can reference each third party user identifier corresponding to the hashed third party identifier of each of the hashed pair(s) 1115.

By way of example, the at least one third party user (and/or user account) of the list of third party users 1120 can include and/or be associated with a third party user identifier corresponding to at least one of the hashed pair(s) 1115. The corresponding hashed pair can be indicative of a first party user (and/or one or more user identifiers thereof) associated with the hashed user group 1025. In this manner, the third party computing system 510 can reference at least one of the subset of users (e.g., users 905A-C of FIG. 9) of the user group (e.g., user group 915 of FIG. 9) by applying the hashing algorithm 1015 to one or more third party user identifier(s) 560 associated with the plurality of third party user (and/or user accounts).

The third party computing system 510 can generate the list of third party users 1120 based, at least in part, on the at least one of the plurality of third party users (e.g., user accounts). For instance, the list of third party users 1120 can include a plurality of third party users (e.g., a subset of third party users 590) associated with respective third party user accounts corresponding to at least one hashed pair. The list of third party users 1120 can include a first subset of the plurality of third party user accounts. Each respective third party user account of the plurality of third party user accounts can be associated with one or more third party user attribute(s) 565 such as any of the user attributes described herein.

Returning to FIG. 8, at (840) of the activity diagram 800, the third party computing system 510 can determine an action based, at least in part, on the communication and list of third party users. For example, with reference to FIG. 11, the third party computing system 510 can determine a third party action 1125 to be taken in response to the first party communication 250 based, at least in part, on the list of third party users 1120, the third party data 555, and/or the requested service operations 1030. The service operations, for example, can include one or more user acquisition operation(s), user servicing operation(s), item offering operation(s), first party informational operation(s), etc. By way of example, the requested service operations can include a request to perform user acquisition operations for the merchant. In such a case, the third party computing system 510 can identify one or more prospective third party users based, at least in part, on the first party communication 250.

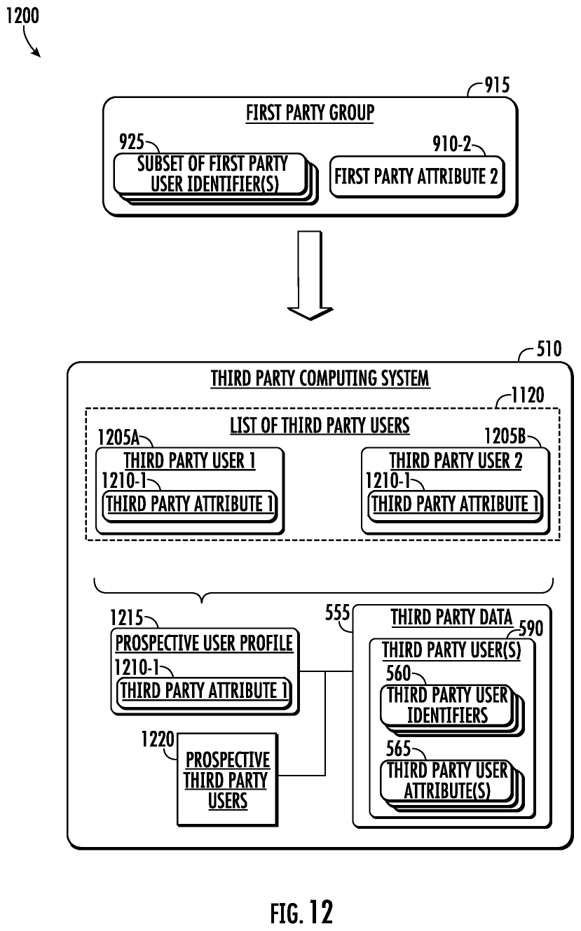

FIG. 12, for example, depicts an example block diagram 1200 for identifying prospective third party users based on a privacy conscious communication according to example aspects of the present disclosure. As depicted, the third party computing system 510 can obtain (e.g., as illustrated in FIG. 11) data indicative of a first party group 915. The first party group 915 can include hashed first party user identifier(s) 925 (e.g., hashed identifier(s), etc.) and, in some implementations, first party attribute(s), such as, for example, first party attribute(s) 910-2 that are shared by each first party user of the first party group 915. In some implementations, the first party attribute(s) 910-2 can be indicative of one or more insights for the first party group 915 such as, for example, an indication that the first party users are high-value users, likely to churn, etc. The third party computing system 510 can reference a list of third party users 1120 based, at least in part, on the first party group 915. Each third party user 1120 can be associated with one or more user attributes. In some cases, the list of third party users 1120 can include one or more third party users 1205A-B associated with at least one common third party attribute 1210-1.

The third party computing system 510 can generate the prospective user profile 1215 based, at least in part on the at least one third party attribute 1210-1. In some implementations, the prospective user profile 1215 can correspond to the first party attribute 910-2 associated with the first party user group 915. For example, the prospective user profile 1215 can be used to identify third-party users with a high probability of sharing the first party attribute 910-2. As an example, the first party attribute 910-2 can include an indication that the first party user(s) of the first party group 915 are high-value users. In such a case, the prospective user profile 1215 can be used to identify third-party users with a high probability of becoming high-value users to the merchant. Other examples for prospective user profile(s) 1215 can include profiles used to identify third-party users likely to churn, likely to buy a specific product, etc.

For example, the third party computing system 510 can identify one or more common attributes 1210-1 associated with the first subset 1205A-B of the plurality of third party users (and/or user accounts) based, at least in part, on the one or more user attributes associated with each respective third party user (and/or user account) of the first subset 1205A-B of the plurality of third party users (and/or user accounts). The third party computing system 510 can generate a prospective user profile 1215 based, at least in part, on the one or more common attributes 1210-1. The prospective user profile 1215, for example, can be descriptive of one or more attributes of a third party user (and/or user account) that increase the likelihood that the third party user (and/or user account) will become a high-value first party user (and/or any other characteristic shared by the user group 915). In addition, or alternatively, in some implementations, a request to perform user acquisition operations for the merchant can include a prospective profile indicative of one or more first party user attribute(s) corresponding to the one or more high-value first party users.

In some implementations, the first party and/or third party computing system(s) 505, 510 can utilize one or more machine-learning model(s) to generate the prospective user profile 1215. The model(s), for example, can include any type of machine-learning model(s) such as any of the model(s) described herein. For instance, the model(s) can include a similar audience model that is trained (e.g., via one or more machine-learning techniques such as backpropagation of errors, etc.) to output the prospective user profile 1215 based, at least in part, on current high-value user(s) and/or prospective high-value user(s). By way of example, the prospective high-value user(s) can include the third party users 1205A-B (and/or user accounts) referenced based, at least in part, on the hashed user group 1025. For example, in some implementations, the similar audience model can be positively trained off of high value users and subsequently negatively trained against low and/or medium value users to reduce overlap between similar user group types.

The third party computing system 510 can identify a second subset 1220 of the plurality of third party users 590 (and/or user accounts) based, at least in part, on the prospective user profile 1215. Each respective third party user (and/or user account) of the second subset 1220 of the plurality of third party users 590 (and/or user accounts) can be distinct from each respective third party user 1205A-B (and/or user account) of the first subset 1120 of the plurality of third party users 590 (and/or user accounts). The second subset 1220 of users (and/or accounts) can identify one or more prospective third party users that are similar to (e.g., share one or more common attributes with) high value users of the first party but are not yet high value customers themselves. The third party computing system 510 can prioritize such users for customer acquisition.

Returning to FIG. 8, at (845) of the activity diagram 800, the third party computing system 510 can initiate an action. For example, with reference to FIG. 11, the third party computing system 510 can initiate one or more third party actions 1125 in response to the service request 290 of the first party communication 250. As one example, the third party computing system 510 can generate one or more content items based, at least in part, on the second subset 1220 of the plurality of third party users 590 (and/or user accounts) and provide data indicative of at least one of the one or more content items (e.g., advertisements, etc.) to one or more user devices 120 associated with the second subset 1220 of the plurality of third party users 590 (and/or user accounts).

The content item(s) can include product advertisements. The third party computing system can initiate the third party action 1125 by providing the product advertisements to third-party users in accordance with the service request 290 of the first party communication 250. The service request 290 can specify a particular advertisement, a type of advertisement, or include information for use in generating third-party specific advertisements. For instance, the information can include instructions to provide messages consistent with a customer's stage in their customer journey such that the third-party can generate stage-specific advertisements keyed to particular first party users. In addition, or alternatively, the information can include instructions to provide messages consistent with a customer's interests such that the third-party can generate product-specific advertisements keyed to particular first party users. As another example, the information can include instructions to provide messages consistent with a customer's value or likelihood of leaving the merchant. In such a case, a service request 290 can authorize the third-party to generate and provide advertisements including product discounts (and/or other incentives) to particular third-party users.

The third party computing system 510 can initiate a third party action 1125 based on merchant product information. For instance, the third party computing system 510 can receive first party data associated with the first party computing system 505. The first party data can include item data indicative of one or more items and/or one or more services associated with the merchant. The third party computing system 510 can generate the one or more content items based, at least in part, on the item data. In this manner, the third party computing system 510 can provide product information to respective third party users (e.g., prospective high value users, etc.) based, at least in part, on the first party communication 250.

The third party computing system 510 can provide data indicative of the one or more content items (e.g., advertisements, etc.) to the one or more referenced third party user(s) 1120 using one or more tools and/or platforms of the third-party (e.g., third-party platform, etc.). By way of example, the third party computing system 510 can provide the data for display within third party user interface(s) 545 hosted by the third party computing system 510. The user interface(s) 545 can include social media platforms, messaging platforms, media platforms, internet searching platforms, cloud storage platforms, gaming platforms, etc. As one example, the third party computing system 510 can be associated with a search engine that provides an internet searching platform. In such a case, the third party computing system 510 can receive input data indicative of a website and at least one third party user in the list of third party users 1120. The third party computing system 510 can provide data indicative of customized third party user interface 545 (e.g., a customized website, etc.) for display to the third party user based, at least in part, on the one or more content items and at least one third party user. The customized third party user interface 545, for example, can present personalized messages (e.g., advertisements keyed to the user's interests, value, and/or other insights service by the merchant) to the third-party user. Such messages can be informed by first party data gathered by the merchant. Moreover, the same (and/or similar) first party communication(s) 250 can be provided to a plurality of different third party platforms such that consistent information is provided to the respective user regardless of the third party platform.

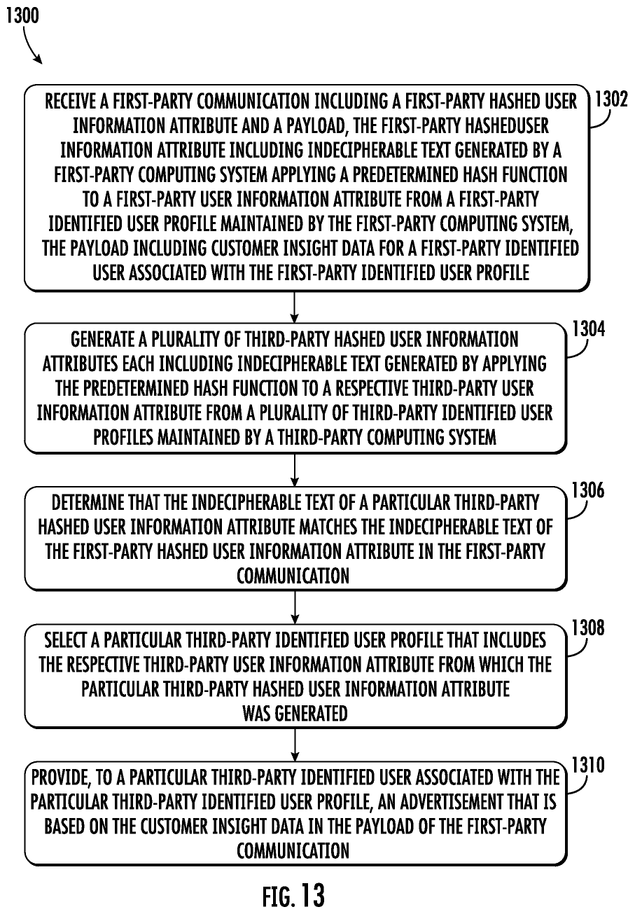

FIG. 13 depicts an example method 1300 for providing a privacy conscious communication according to example aspects of the present disclosure. One or more portion(s) of method 1300 can be implemented by one or more computing device(s) such as, for example, those shown in FIGS. 1-6, 10-12, and 16. Moreover, one or more portion(s) of the method 1300 can be implemented as an algorithm on the hardware components of the device(s) described herein (e.g., as in FIGS. 1-6, 10-12, and 16) to, for example, provide privacy conscious communications. FIG. 13 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (1302), the method 1300 can include receiving first party communication including a first-party hashed user information attribute and a payload. The first-party hashed user information attribute can include indecipherable text generated by a first-party computing system applying a predetermined hash function to a first-party user information attribute from a first-party identified user profile maintained by the first-party computing system. The payload can include customer insight data for a first-party identified user associated with the first-party identified user profile. In some examples, the first-party communication be received by an advertisement platform 115 or third party computing system 510.

At (1304), the method 1300 can generating a plurality of third-party hashed user information attributes. Each third-party hashed user information attribute can include indecipherable text generated by applying the predetermined hash function to a respective third-party user information attribute from a plurality of third-party identified user profiles maintained by a third-party computing system.

At (1306), the method 1300 can include determining that the indecipherable text of a particular third-party hashed user information attribute matches the indecipherable text of the first-party hashed user information attribute in the first-party communication.

At (1308), the method 1300 can include selecting a particular third-party identified user profile that includes the respective third-party user information attribute from which the particular third-party hashed user information attribute was generated.

At (1310), the method 1300 can include providing, to a particular third-party identified user associated with the particular third-party identified user profile, an advertisement that is based on the customer insight data in the payload of the first-party communication.

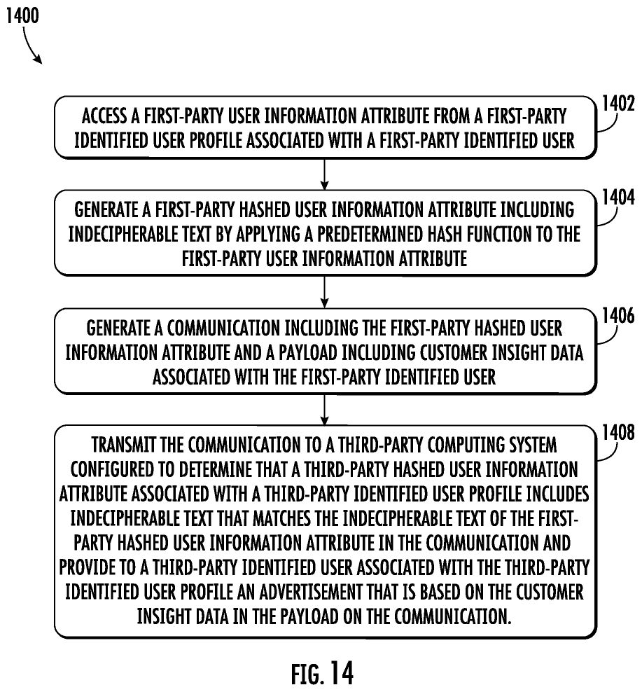

FIG. 14 depicts an example method 1400 for providing service operations for a first party according to example aspects of the present disclosure. One or more portion(s) of method 1400 can be implemented by one or more computing device(s) such as, for example, those shown in FIGS. 1-6, 10-12, and 16. Moreover, one or more portion(s) of the method 1400 can be implemented as an algorithm on the hardware components of the device(s) described herein (e.g., as in FIGS. 1-6, 10-12, and 16) to, for example, provide service operations for a first party. FIG. 14 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (1402), the method 1400 can include accessing a first-party user information attribute from a first-party identified user profile associated with a first-party identified user. For example, a merchant computing device can access a first-party user information attribute from a first-party identified user profile.

At (1404), the method 1400 can include generating a first-party hashed user information attribute including indecipherable text by applying a predetermined hash function to the first-party user information attribute.

At (1406), the method 1400 can include generating a communication including the first-party hashed user information attribute and a payload including customer insight data associated with the first-party identified user.

At (1408), the method 1400 can include transmitting the communication to a third-party computing system. The third-party computing system can be configured to determine that a third-party hashed user information attribute associated with a third-party identified user profile includes indecipherable text that matches the indecipherable text of the first-party hashed user information attribute in the communication. At 1408, method 1400 can include providing to a third-party identified user associated with the third-party identified user profile an advertisement that is based on the customer insight data in the payload of the communication.

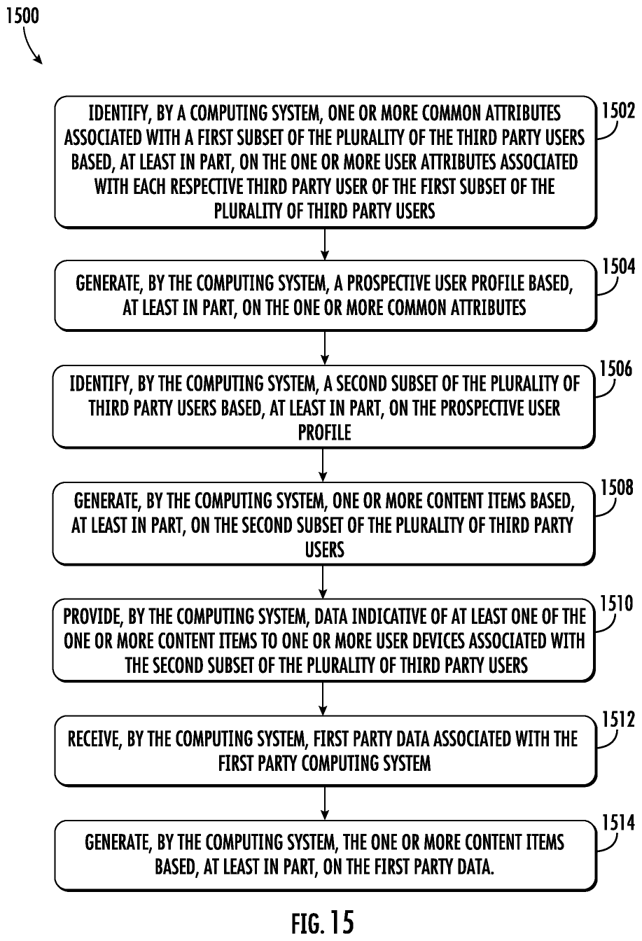

FIG. 15 depicts an example method 1500 for performing user acquisition operations for a first party according to example aspects of the present disclosure. One or more portion(s) of method 1500 can be implemented by one or more computing device(s) such as, for example, those shown in FIGS. 1-6, 10-12, and 16. Moreover, one or more portion(s) of the method 1500 can be implemented as an algorithm on the hardware components of the device(s) described herein (e.g., as in FIGS. 1-6, 10-12, and 16) to, for example, perform user acquisition operations for a first party. FIG. 15 depicts steps performed in a particular order for purposes of illustration and discussion. Those of ordinary skill in the art, using the disclosures provided herein, will understand that the steps of any of the methods discussed herein can be adapted, rearranged, expanded, omitted, or modified in various ways without deviating from the scope of the present disclosure.

At (1502), the method 1500 can include identifying one or more common attributes associated with a first subset of the plurality of third party users based, at least in part, on the one or more user attributes associated with each respective third party user of the first subset of the plurality of third party users. For example, an advertisement platform 115 or third party computing system 510 can identify the one or more common attributes associated with the first subset of the plurality of third party users based, at least in part, on the one or more user attributes associated with each respective third party user of the first subset of the plurality of third party users.

At (1504), the method 1500 can include generating a prospective user profile based, at least in part, on the one or more common attributes. For example, the computing system can generate the prospective user profile based, at least in part, on the one or more common attributes.

At (1506), the method 1500 can include identifying a second subset of the plurality of third party users based, at least in part, on the prospective user profile. For example, the computing system can identify the second subset of the plurality of third party users based, at least in part, on the prospective user profile.

At (1508), the method 1500 can include generating one or more content items based, at least in part, on the second subset of the plurality of third party users. For example, the computing system can generate the one or more content items based, at least in part, on the second subset of the plurality of third party users.

At (1514), the method 1500 can include providing data indicative of at least one of the one or more content items to one or more user devices associated with the second subset of the plurality of third party users. For example, the computing system can provide the data indicative of at least one of the one or more content items to the one or more user devices associated with the second subset of the plurality of third party users.

At (1512), the method 1500 can include receiving first party data associated with the first party computing system. For example, the computing system can receive the first party data associated with the first party computing system.

At (1514), the method 1500 can include generating the one or more content items based, at least in part, on the first party data. For example, the computing system can generate the one or more content items based, at least in part, on the first party data.

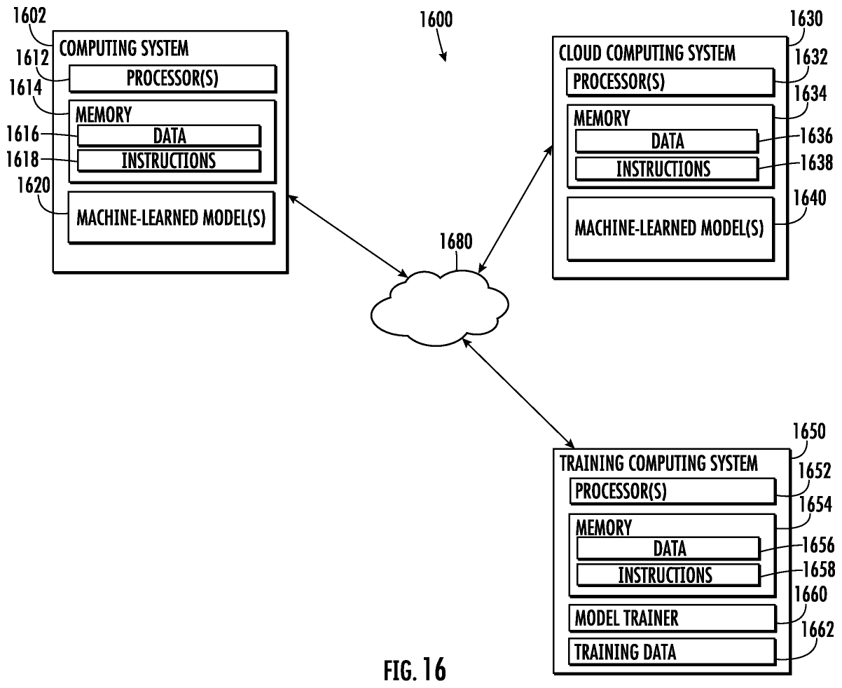

FIG. 16 depicts a block diagram of an example machine-learning computing environment 1600 according to example aspects of the present disclosure. The environment 1600 includes a computing system 1602 (e.g., first party computing system 505, third party computing system 510, etc. of FIG. 1) that performs predictive analytics according to example embodiments of the present disclosure. In addition, the environment 1600 includes a server computing system 1630 (e.g., merchant cloud computing platform 105, intermediary cloud computing platform 240, cloud computing system 515, etc.), and a training computing system 1650 that are communicatively coupled over a network 1680.

The computing system 1602 can include one or more of any type of computing device(s), such as, for example, one or more servers, personal computing device (e.g., laptop or desktop), a mobile computing device (e.g., smartphone or tablet), or any other type of computing device(s).

The computing system 1602 includes one or more processors 1612 and a memory 164. The one or more processors 1612 can be any suitable processing device (e.g., a processor core, a microprocessor, an ASIC, an FPGA, a controller, a microcontroller, etc.) and can be one processor or a plurality of processors that are operatively connected. The memory 1614 can include one or more non-transitory computer-readable storage media, such as RAM, ROM, EEPROM, EPROM, flash memory devices, magnetic disks, etc., and combinations thereof. The memory 1614 can store data 1616 and instructions 1618 which are executed by the processor 1612 to cause the computing system 1602 to perform operations.

In some implementations, the computing system 1602 can store or include one or more model(s) 1620 (e.g., predictive model(s), etc.). For example, the models 1620 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Some example machine-learned models can leverage an attention mechanism such as self-attention. For example, some example machine-learned models can include multi-headed self-attention models (e.g., transformer models). Example models 1620 are discussed with reference to the prediction system of FIG. 2.

In some implementations, the one or more model(s) 1620 can be received from the server computing system 1630 over network 1680, stored in the computing system memory 1614, and then used or otherwise implemented by the one or more processors 1612. In some implementations, the computing system 1602 can implement multiple parallel instances of the model(s) 1620 (e.g., to perform parallel predictive analytics across multiple instances of the predictive model(s)).

More particularly, model(s) can include one or more insight model(s) such as, for example, value-based model(s) configured to output value segmentations (e.g., high, medium, low value segmentations, etc.) based on first party data, global data, and/or third party data, predictive churn model(s) configured to output churn segmentations (e.g., high, medium, low churn rate, etc.), predictive item specific model(s) configured to output item interest segmentations (e.g., high, medium, low interest with respect to respective item(s), etc.) based on first party data, and/or any other model or combinations thereof described herein.

Additionally, or alternatively, one or more models 1640 can be included in or otherwise stored and implemented by the server computing system 1630 that communicates with the computing system 1602 according to a client-server relationship. For example, the models 1640 can be implemented by the server computing system 1630 as a portion of a web service (e.g., a cloud marketing service). Thus, one or more models 1620 can be stored and implemented at the computing system 1602 and/or one or more models 1640 can be stored and implemented at the server computing system 1630.

The server computing system 1630 includes one or more processors 1632 and a memory 1634. The one or more processors 1632 can be any suitable processing device (e.g., a processor core, a microprocessor, an ASIC, an FPGA, a controller, a microcontroller, etc.) and can be one processor or a plurality of processors that are operatively connected. The memory 1634 can include one or more non-transitory computer-readable storage media, such as RAM, ROM, EEPROM, EPROM, flash memory devices, magnetic disks, etc., and combinations thereof. The memory 1634 can store data 1636 and instructions 1638 which are executed by the processor 1632 to cause the server computing system 1630 to perform operations.

In some implementations, the server computing system 1630 includes or is otherwise implemented by one or more server computing devices. In instances in which the server computing system 1630 includes plural server computing devices, such server computing devices can operate according to sequential computing architectures, parallel computing architectures, or some combination thereof.

As described above, the server computing system 1630 can store or otherwise include one or more models 1640. For example, the models 1640 can be or can otherwise include various machine-learned models. Example machine-learned models include neural networks or other multi-layer non-linear models. Example neural networks include feed forward neural networks, deep neural networks, recurrent neural networks, and convolutional neural networks. Some example machine-learned models can leverage an attention mechanism such as self-attention. For example, some example machine-learned models can include multi-headed self-attention models (e.g., transformer models). Example models 1640 are discussed with reference to FIG. 2.

The computing system 1602 and/or the server computing system 1630 can train the models 1620 and/or 1640 via interaction with the training computing system 1650 that is communicatively coupled over the network 1680. The training computing system 1650 can be separate from the server computing system 1630 or can be a portion of the server computing system 1630.

The training computing system 1650 includes one or more processors 1652 and a memory 1654. The one or more processors 1652 can be any suitable processing device (e.g., a processor core, a microprocessor, an ASIC, an FPGA, a controller, a microcontroller, etc.) and can be one processor or a plurality of processors that are operatively connected. The memory 1654 can include one or more non-transitory computer-readable storage media, such as RAM, ROM, EEPROM, EPROM, flash memory devices, magnetic disks, etc., and combinations thereof. The memory 1654 can store data 1656 and instructions 1658 which are executed by the processor 1652 to cause the training computing system 1650 to perform operations. In some implementations, the training computing system 1650 includes or is otherwise implemented by one or more server computing devices.

The training computing system 1650 can include a model trainer 1660 that trains the machine-learned models 1620 and/or 1640 stored at the computing system 1602 and/or the server computing system 1630 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 1660 can perform a number of generalization techniques (e.g., weight decays, dropouts, etc.) to improve the generalization capability of the models being trained.

In particular, the model trainer 1660 can train the models 1620 and/or 1640 based on a set of training data 1662. The training data 1662 can include, for example, the first party data, global data, and/or third party data described herein with reference to the first party. In addition, or alternatively, the training data 1662 can include universal first party data, global data, and/or third party data received from a plurality of different first parties associated with the service computing system 1630. In some implementations, the training data 1662 can include labeled first party data, global data, and/or third party data including labels indicative of a first party user's actual activity and/or any other labels for facilitating the training of the models 1620 and/or 1640 (e.g., via one or more supervisory training techniques, etc.).

In some implementations, if the computing system 1602 has provided consent, the training examples can be provided by the computing system 1602. Thus, in such implementations, the model 1620 provided to the computing system 1602 can be trained by the training computing system 1650 on first party (and/or third party) specific data received from the computing system 1602. In some instances, this process can be referred to as personalizing the model.

The model trainer 1660 includes computer logic utilized to provide desired functionality. The model trainer 1660 can be implemented in hardware, firmware, and/or software controlling a general purpose processor. For example, in some implementations, the model trainer 1660 includes program files stored on a storage device, loaded into a memory and executed by one or more processors. In other implementations, the model trainer 1660 includes one or more sets of computer-executable instructions that are stored in a tangible computer-readable storage medium such as RAM, hard disk, or optical or magnetic media.

The network 1680 can be any type of communications network, such as a local area network (e.g., intranet), wide area network (e.g., Internet), or some combination thereof and can include any number of wired or wireless links. In general, communication over the network 1680 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 16 illustrates one example computing system that can be used to implement the present disclosure. Other computing systems can be used as well. For example, in some implementations, the computing system 1602 can include the model trainer 1660 and the training data 1662. In such implementations, the models 1620 can be both trained and used locally at the computing system 1602. In some of such implementations, the computing system 1602 can implement the model trainer 1660 to personalize the models 1620 based on first party (and/or third party) specific data.

The technology discussed herein makes reference to servers, databases, software applications, and other computer-based systems, as well as actions taken and information sent to and from such systems. One of ordinary skill in the art will recognize that the inherent flexibility of computer-based systems allows for a great variety of possible configurations, combinations, and divisions of tasks and functionality between and among components. For instance, server processes discussed herein may be implemented using a single server or multiple servers working in combination. Databases and applications may be implemented on a single system or distributed across multiple systems. Distributed components may operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method, comprising:
receiving, by a third-party computing system comprising one or more computing devices, a first-party communication including a first-party hashed user information attribute and a payload, the first-party hashed user information attribute including indecipherable text generated by a first-party computing system applying a predetermined hash function to a first-party user information attribute from a first-party identified user profile maintained by the first-party computing system, the payload including customer insight data for a first-party identified user associated with the first-party identified user profile;
generating, by the third-party computing system, a plurality of third-party hashed user information attributes each including indecipherable text generated by applying the predetermined hash function to a respective third-party user information attribute from a plurality of third-party identified user profiles maintained by the third-party computing system;
determining, by the third-party computing system, that the indecipherable text of a particular third-party hashed user information attribute matches the indecipherable text of the first-party hashed user information attribute in the first-party communication;
selecting, by the third-party computing system, a particular third-party identified user profile that includes the respective third-party user information attribute from which the particular third-party hashed user information attribute was generated; and
providing, by the third-party computing system to a particular third-party identified user associated with the particular third-party identified user profile, an advertisement that is based on the customer insight data in the payload of the first-party communication.

2. The computer-implemented method of claim 1, further comprising:
determining, by the third-party computing system, that the particular third-party identified user associated with the particular third-party identified user profile is a same person as the first-party identified user associated with the first-party identified user profile.

3. The computer-implemented method of claim 1, further comprising:
receiving, by the third-party computing system, one or more secure communication standards from an orchestration service, wherein the one or more secure communication standards identify the predetermined hash function.

4. The computer-implemented method of claim 3, wherein the one or more secure communication standards identify one or more user information attribute types, and wherein the respective third-party user information attribute from the plurality of third-party identified user profiles maintained by the third-party computing system corresponds to at least one of the one or more user information attribute types.

5. The computer-implemented method of claim 1, wherein selecting, by the third-party computing system, the particular third-party identified user profile, comprises:
determining, by the third-party computing system, a match type associated with the respective third-party user information attribute from which the particular third-party hashed user information attribute was generated; and
in response to the match type corresponding to an allowed match type, selecting, by the third-party computing system, the particular third-party identified user profile.

6. The computer-implemented method of claim 5, wherein the particular third-party identified user profile comprises a collection of third-party user information attributes corresponding to the particular third-party identified user.

7. The computer-implemented method of claim 1, wherein:
the first-party user information attribute is a first first-party user information attribute and the first-party hashed user information attribute is a first first-party hashed user information attribute;
the first-party communication includes a second first-party hashed user information attribute including indecipherable text generated by the first-party computing system applying the predetermined hash function to a second first-party user information attribute from the first-party identified user profile maintained by the first-party computing system; and
the indecipherable text of the second first-party hashed user information attribute does not match any third-party hashed user information attribute of the particular third-party identified user profile.

8. The computer-implemented method of claim 1, wherein the customer insight data is indicative of an interested product for the first-party identified user.

9. The computer-implemented method of claim 9, wherein the advertisement for the particular third-party identified user comprises product information for the interested product.

10. A third-party computing system, comprising:
one or more processors; and
a memory storing instructions that when executed by the one or more processors cause the first-party computing system to perform operations comprising:
receiving a first-party communication including a first-party hashed user information attribute and a payload, the first-party hashed user information attribute including indecipherable text generated by a first-party computing system applying a predetermined hash function to a first-party user information attribute from a first-party identified user profile maintained by the first-party computing system, the payload including customer insight data for a first-party identified user associated with the first-party identified user profile;
generating a plurality of third-party hashed user information attributes each including indecipherable text generated by applying the predetermined hash function to a respective third-party user information attribute from a plurality of third-party identified user profiles maintained by the third-party computing system;
determining that the indecipherable text of a particular third-party hashed user information attribute matches the indecipherable text of the first-party hashed user information attribute in the first-party communication;
selecting a particular third-party identified user profile that includes the respective third-party user information attribute from which the particular third-party hashed user information attribute was generated; and
providing, to a particular third-party identified user associated with the particular third-party identified user profile, an advertisement that is based on the customer insight data in the payload of the first-party communication.

11. The third-party computing system of claim 10, the operations further comprising:
determining that the particular third-party identified user associated with the particular third-party identified user profile is a same person as the first-party identified user associated with the first-party identified user profile.

12. The third-party computing system of claim 10, the operations further comprising:
receiving one or more secure communication standards from an orchestration service, wherein the one or more secure communication standards identify the predetermined hash function.

13. The third-party computing system of claim 12, wherein the one or more secure communication standards identify one or more user information attribute types, and wherein the respective third-party user information attribute from the plurality of third-party identified user profiles maintained by the third-party computing system corresponds to at least one of the one or more user information attribute types.

14. The third-party computing system of claim 10, wherein selecting the particular third-party identified user profile, comprises:
determining a match type associated with the respective third-party user information attribute from which the particular third-party hashed user information attribute was generated; and
in response to the match type corresponding to an allowed match type, selecting the particular third-party identified user profile.

15. The third-party computing system of claim 14, wherein the particular third-party identified user profile comprises a collection of third-party user information attributes corresponding to the particular third-party identified user.

16. The third-party computing system of claim 10, wherein the first-party computing system is associated with a merchant, and the third-party computing system is associated with an advertising platform.

17. The third-party computing system of claim 16, wherein the customer insight data is indicative of an interested product for the first-party identified user that is offered by the merchant, and wherein the advertisement for the particular third-party identified user comprises product information for the interested product.

18. The third-party computing system of claim 16, wherein the first-party identified user is a customer of the merchant, and wherein the particular third-party identified user is a user of the advertising platform.

19. One or more non-transitory computer-readable media comprising instructions that when executed by one or more computing devices cause the one or more computing devices to perform operations comprising:
receiving a first-party communication including a first-party hashed user information attribute and a payload, the first-party hashed user information attribute including indecipherable text generated by a first-party computing system applying a predetermined hash function to a first-party user information attribute from a first-party identified user profile maintained by the first-party computing system, the payload including customer insight data for a first-party identified user associated with the first-party identified user profile;
generating a plurality of third-party hashed user information attributes each including indecipherable text generated by applying the predetermined hash function to a respective third-party user information attribute from a plurality of third-party identified user profiles maintained by the third-party computing system;
determining that the indecipherable text of a particular third-party hashed user information attribute matches the indecipherable text of the first-party hashed user information attribute in the first-party communication;
selecting a particular third-party identified user profile that includes the respective third-party user information attribute from which the particular third-party hashed user information attribute was generated; and
providing, to a particular third-party identified user associated with the particular third-party identified user profile, an advertisement that is based on the customer insight data in the payload of the first-party communication.

20. The one or more non-transitory computer-readable media of claim 19, the operations further comprising:
determining that the particular third-party identified user associated with the particular third-party identified user profile is a same person as the first-party identified user associated with the first-party identified user profile.
